(19) United States
(12) Patent Application Publication
(10) Pub. No.: US 2026/0166428 A1
(43) Pub. Date: Jun. 18, 2026

(54) ELECTRONIC DEVICE, METHOD, AND COMPUTER-READABLE STORAGE MEDIUM FOR DISPLAYING IN GAME ENVIRONMENT

(71) Applicant: NCSOFT Corporation, Seoul (KR)

(72) Inventors: Jonghoon KIM, Seongnam-si (KR); Jaemin SHIM, Seongnam-si (KR); Doohyun CHO, Seongnam-si (KR); Yunsu HAN, Seongnam-si (KR)

(73) Assignee: NCSOFT Corporation, Seoul (KR)

(21) Appl. No.: 19/533,552

(22) Filed: Feb. 9, 2026

Related U.S. Application Data
(63) Continuation of application No. PCT/KR2024/003724, filed on Mar. 25, 2024.

(51) Int. Cl. A63F 13/533; A63F 13/56; A63F 13/577

(52) U.S. Cl. CPC A63F 13/533; A63F 13/577; A63F 13/56

(57) ABSTRACT

An electronic device that displays a screen on the display, while the screen is displayed, detects an event to cause a player character to ride a vehicle character associated with the player character in the screen, identifies a portion of the player character to be linked to a portion of the vehicle character when the player character is ridden on the vehicle character, generates an animation representing the player character riding the vehicle character by changing a distance between the portion of the vehicle character and the portion of the player character, and displays the animation on the display.

### CROSS-REFERENCE TO RELATED APPLICATIONS

This application is a continuation of International Application No. PCT/KR2024/003724, filed on Mar. 25, 2024, the disclosure of which is incorporated by reference herein in its entirety.

### BACKGROUND

### 1. Field

The present disclosure relates to an electronic device, a method, and a computer readable storage medium for displaying in a game environment.

### 2. Description of Related Art

An electronic device may include a display. The display may be used to display an image. The display may be used to provide a game environment. For example, the display may display a screen received from a software application for a game. For example, the display may receive data on the screen from a processor of the electronic device and display the screen.

The above-described information may be provided as a related art for the purpose of helping understanding of the present disclosure.

No argument or decision is made as to whether any of the above description may be applied as a prior art related to the present disclosure.

### SUMMARY

According to an aspect of the disclosure, there is provided a non-transitory computer readable storage medium storing one or more programs, the one or more programs including instructions that, when executed by an electronic device having a display, cause the electronic device to: display a screen on the display; while the screen is displayed, detect an event to cause a player character to ride a vehicle character associated with the player character in the screen; identify a portion of the player character to be linked to a portion of the vehicle character when the player character is ridden on the vehicle character; generate an animation representing the player character riding the vehicle character by changing a distance between the portion of the vehicle character and the portion of the player character; and display the animation on the display.

The one or more programs may include instructions that, when executed by the electronic device, cause the electronic device to: identify a distance between the vehicle character and the player character, and based on identifying that the distance between the vehicle character and the player character becomes less than a reference distance, display the animation.

The distance between the vehicle character and the player character may be a distance between a representative position of the player character and a representative position of the vehicle character, and wherein the representative position of the player character may be in between two feet of the player character.

The one or more programs may include instructions that, when executed by the electronic device, cause the electronic device to: identify reference data on the distance being changed in accordance with an elapse of time in a time interval in which the animation will be displayed; and generate the animation by changing the distance using the reference data.

The one or more programs may include instructions that, when executed by the electronic device, cause the electronic device to generate the animation by changing the distance by applying a weight to the reference data.

The portion of the player character positioned within an area outside the player character, extended from a portion of a body of the player character, associated with the player character.

The portion of the vehicle character may be positioned within an area outside the vehicle character, extended from a portion of a body of the vehicle character, associated with the vehicle character.

The one or more programs may include instructions that, when executed by the electronic device, cause the electronic device to: identify a movement state of the vehicle character; based on identifying that the movement state is a first movement state: identify the portion of the player character to be linked to the portion of the vehicle character when the player character is ridden on the vehicle character; and generate the animation by changing the distance between the portion of the vehicle character and the portion of the player character, based on identifying that the movement state is a second movement state: identify another portion of the player character to be linked to another portion of the vehicle character when the player character is ridden on the vehicle character; and generate another animation by changing a distance between the another portion of the vehicle character and the another portion of the player character; and display the animation and the another animation on the display.

The one or more programs may include instructions that, when executed by the electronic device, cause the electronic device to: identify another portion of the player character to be linked to another portion of the vehicle character when the player character is ridden on the vehicle character; generate the animation representing the player character riding the vehicle character by changing a distance between the another portion of the vehicle character and the another portion of the player character; and display the animation on the display.

The one or more programs may include instructions that, when executed by the electronic device, cause the electronic device to: change the distance by decreasing the distance; while the distance is being decreased: identify a first posture of the player character to be ridden on the vehicle character in accordance with the portion of the player character separated from the portion of the vehicle character by a first distance; and identify a second posture of the player character to be ridden on the vehicle character in accordance with the portion of the player character separated from the portion of the vehicle character by a second distance shorter than the first distance; and based on the first posture and the second posture, generate the animation, wherein the second posture may be at least partially different from the first posture.

According to an aspect of the disclosure, there is provided a non-transitory computer readable storage medium storing one or more programs, the one or more programs including instructions that, when executed by an electronic device having a display, cause the electronic device to: display a screen on the display; while the screen is displayed, detect an event to cause a player character to ride a vehicle character associated with the player character in the screen; identify a portion of the player character to be linked to a portion of the vehicle character when the player character is ridden on the vehicle character; identify a first posture of the player character before linking the portion of the player character to the portion of the vehicle character; identify a second posture of the player character by linking the portion of the player character to the portion of the vehicle character; generate a first image including the player character having the first posture and a second image including the player character having the second posture; generate at least one third image by combining the first image and the second image; generate an animation using the first image, the second image, and the at least one third image; and display the animation on the display.

The one or more programs may include instructions that, when executed by the electronic device, cause the electronic device to: identify a distance between the vehicle character and the player character; and based on identifying that the distance between the vehicle character and the player character becomes less than a reference distance, display the animation.

The distance between the vehicle character and the player character may be a distance between a representative position of the player character and a representative position of the vehicle character, and wherein the representative position of the player character may be in between two feet of the player character.

The one or more programs may include instructions that, when executed by the electronic device, cause the electronic device to: identify reference data on a first weight to be applied to the first image and a second weight to be applied to the second image; and generate the at least one third image by combining the first image and the second image via applying the first weight from the reference data to the first image and applying the second weight from the reference data to the second image, and wherein the first weight and the second weight are changed based on an elapse of time in a time interval in which the animation will be displayed.

The one or more programs may include instructions, when executed by the electronic device, to cause the electronic device to, further based on changing a distance between the portion of the vehicle character and the portion of the player character, generate the at least one third image, and generate the animation using the first image, the second image, and the at least one third image.

The one or more programs may include instructions, when executed by the electronic device, cause the electronic device to: identify other reference data on the distance being changed based on the elapse of time in the time interval in which the animation will be displayed; and based on changing the distance using the other reference data, generate the at least one third image.

The one or more programs may include instructions that, when executed by the electronic device, cause the electronic device to, based on applying a weight to the reference data and applying another weight to the other reference data, generate the at least one third image.

The portion of the player character may be positioned within an area outside the player character, extended from a portion of a body of the player character, associated with the player character.

The portion of the vehicle character may be positioned within an area outside the vehicle character, extended from a portion of a body of the vehicle character, associated with the vehicle character.

The one or more programs may include instructions that, when executed by the electronic device, cause the electronic device to: identify a movement state of the vehicle character; based on identifying that the movement state is a first movement state, generate the at least one third image by combining the first image and the second image; based on identifying that the movement state is a second movement state: identify another portion of the player character to be linked to another portion of the vehicle character when the player character is ridden on the vehicle character; identify a third posture of the player character before linking the another portion of the player character to the another portion of the vehicle character; identify a fourth posture of the player character by linking the another portion of the player character to the another portion of the vehicle character; generate a fourth image including the player character having the third posture and a fifth image including the player character having the fourth posture; generate at least one sixth image by combining the fourth image and the fifth image; and generate the animation by combining the first image, the second image, the at least one third image, the fourth image, the fifth image, and the at least one sixth image.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 illustrates an example of a player character riding a vehicle character.

FIG. 2 is a simplified block diagram of an exemplary electronic device.

FIG. 3 is a flowchart illustrating an exemplary method of generating an animation by changing a distance between a portion of a vehicle character and a portion of a player character.

FIG. 4 illustrates an example of a screen including a player character.

FIG. 5 illustrates an example of an appearance of a vehicle character.

FIG. 6 illustrates an example of an event.

FIG. 7 illustrates an example of a portion of a vehicle character positioned outside the vehicle character and a portion of a player character positioned outside the player character.

FIG. 8 illustrates an example of a portion of a vehicle character and a portion of a player character that may vary in accordance with a state of the vehicle.

FIG. 9 illustrates an example of position information of a portion of a vehicle character and position information of a portion of a player character.

FIG. 10 illustrates an example of a distance between a portion of a vehicle character and a portion of a player character.

FIG. 11 illustrates an example of changing a distance between a portion of a vehicle character and a portion of a player character.

FIG. 12 illustrates an example of generating a posture of a state in which a player character is riding a vehicle character using a fullbody inverse kinematics (IK).

FIG. 13 illustrates an example of reference data.

FIG. 14 is a flowchart illustrating an exemplary method of generating an animation using a first image, a second image, and at least one third image.

FIG. 15 illustrates an example of a weight of a first image and a weight of a second image.

FIG. 16 illustrates an example of a first image, a second image, and a third image.

FIG. 17 illustrates an example of reference data.

FIG. 18 is a flowchart of generating an animation using a first image, a second image, and at least one third image by generating the at least one third image further based on changing a distance between a portion of a vehicle character and a portion of a player character.

### DETAILED DESCRIPTION

The electronic device according (or the external electronic device) to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to an embodiment of the disclosure, the electronic devices (or the external electronic device) are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “coupled to,” “connected with,” or “connected towith” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 100). For example, a processor of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which where data is semi-permanently stored in the storage medium and where a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

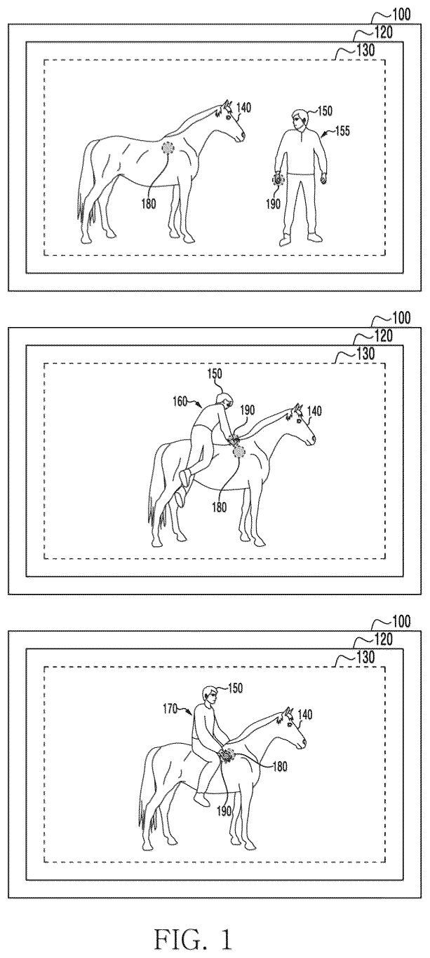

FIG. 1 illustrates an example of a player character riding a vehicle character.

Referring to FIG. 1, an electronic device 100 may display, on a display 120, a screen 130 on which a vehicle character 140 (e.g., horse character) and a player character (PC) 150 are displayed.

For example, the player character 150 may include a playable character, which is a visual object performing an action available in a game environment based on an input of a user associated with account information (or an electronic device) corresponding to the player character 150. The player character 150 may be different from a non-player character (NPC) that the user may not manipulate. For example, the NPC may indicate a preset character when designing a server providing the virtual space or the virtual space. For example, the NPC may perform interaction with the player character 150. For example, the NPC may include a monster. The following descriptions exemplify a player character riding a vehicle character, but these are only examples. The player character riding the vehicle character exemplified below may be replaced by an NPC riding the vehicle character.

For example, the vehicle character 140 may include a visual object which the player character 150 may ride. For example, the vehicle character 140 may assist movement of the player character 150. For example, the vehicle character 140 may move separately from the player character 150 before riding of the player character 150. For example, the vehicle character 140 may move together with the player character 150 riding the vehicle character 140. For example, the vehicle character 140 and the player character 150 may be visual objects represented in three dimensions.

For example, the electronic device 100 may move the vehicle character 140 in a direction to the player character 150 based on an event. For example, the event may be an input to a specific portion on a screen. For example, the electronic device 100 may display the vehicle character 140 on the screen 130 based on the event and move the vehicle character 140 in the direction to the player character 150.

For example, a posture of the player character 150 on the screen 130 may vary in accordance with whether the player character 150 rides the vehicle character 140. For example, a first posture 155 of the player character 150 before (or immediately before) being ridden on the vehicle character 140 and a second posture 170 of the player character 150 after (or immediately after) being ridden on the vehicle character 140 may be different from each other. For example, the posture of the player character 150 may change from the first posture 155 to the second posture 170 while the player character 150 rides the vehicle character 140. For example, the first posture 155 may be changed to the second posture 170 via at least one posture 160 (e.g., an intermediate posture between the first posture 155 and the second posture 170).

For example, the electronic device 100 may generate an animation in which the player character 150 rides the vehicle character 140. As a non-limiting example, a method of generating the animation in advance in which the player character 150 rides the vehicle character 140 and displaying the animation generated in advance when an event occurs in which the player character 150 rides the vehicle character 140 may be considered. However, this method may increase complexity of data management for the game. As a non-limiting example, when the event occurs in which the player character 150 rides the vehicle character 140, a method of generating and displaying the animation in which the player character 150 rides the vehicle character 140 using a fullbody inverse kinematics (IK) may be considered. However, this method may cause unnatural movement of the player character 150 and/or the vehicle character 140.

An electronic device to be exemplified below may generate the animation in which the player character 150 rides the vehicle character 140, based on determining the at least one posture 160 by changing a distance between a portion 190 of the vehicle character 140 and a portion 180 of the player character 150. The electronic device to be exemplified below may generate the animation in which the player character 150 rides the vehicle character 140, based on determining the at least one posture 160 by combining the first posture 155 of the player character 150 and the second posture 170 of the player character 150.

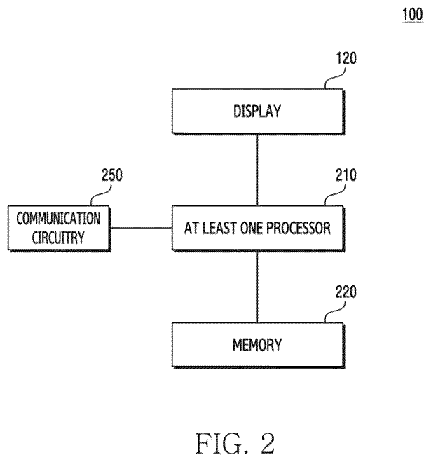

The electronic device 100 exemplified below may include components for the operations. The components are exemplified in a description of FIG. 2.

FIG. 2 is a simplified block diagram of an exemplary electronic device.

Referring to FIG. 2, an electronic device 100 may include a display 120, at least one processor 210, memory 220, and communication circuitry 250. The components (e.g., the display 120 and the communication circuitry 250) exemplified above are merely exemplary. For example, the electronic device 100 may include other components (e.g., power management integrated circuitry (PMIC), or a rechargeable battery). For example, some components may be omitted from the electronic device 100. For example, some components may be integrated into one component.

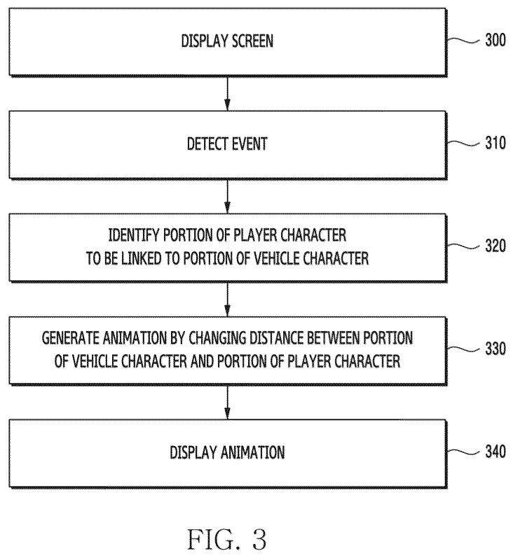

The at least one processor 210 may be used to control at least a portion of the display 120, the memory 220, and the communication circuitry 250. The at least one processor 210 may be configured to cause the electronic device 100 to execute at least a portion of operations exemplified in a description of FIGS. 3 to 18 below. For example, the at least one processor 210 may execute at least a portion of the operations exemplified in the description of FIGS. 3 to 18 below by executing instructions stored in the memory 220.

The at least one processor 210 may be implemented with one or more integrated circuitry (IC) chips and may execute various data processes. The at least one processor 210 may include at least one electrical circuitry and may distribute instructions (or a program, data, and the like) stored in the memory 220 individually or collectively. The at least one processor 210 may include a set of processors including one or more processing circuits. The at least one processor 210 may include any operational processing circuitry to control performance and operations of one or more components of the electronic device 100.

For example, the at least one processor 210 may include a central processing unit (CPU) (or central processing circuitry). For example, the at least one processor 210 may include a graphic processing unit (GPU) (or graphic processing circuitry). For example, the at least one processor 210 may include a neural processing unit (or neural processing circuitry, or an artificial intelligence (AI) chip). For example, the at least one processor 210 may include a display processing unit (DPU) (or display control circuitry) for the display 120. For example, the at least one processor 210 may include a memory controller (or memory control circuitry) for the memory 220 (e.g., volatile memory) and/or a storage controller (or storage control circuitry) for the memory 220 (e.g., non-volatile memory).

The display 120 may be used to display a screen (e.g., visual information, visual data, and/or an image) provided from a software application for a game. For example, the display 120 may be used to display the screen obtained (or generated) (or rendered) by the at least one processor 210. For example, the display 120 may be used to display the screen provided from the at least one processor 210.

The memory 220 may include one or more storage mediums (or one or more storage devices). For example, the memory 220 may include a memory assembly including one or more storage mediums. For example, the one or more storage mediums may include permanent memory (e.g., a hard drive, flash memory, read-only memory (ROM)), semi-permanent memory, storage (or a storage assembly) of any other suitable type, or any combination thereof. The memory 220 may include cache memory, which is memory of one or more different types used to temporarily store data for a function (or a feature) of the electronic device 100. As a non-limiting example, the cache memory may be included in the processor 210. The memory 220 may be incorporated onto one or more suitable types of components (e.g., a subscriber identity module (SIM) card and/or a secure digital (SD) card) that may be fixedly embedded in the electronic device 100 or repeatedly inserted into the electronic device 100 and removed from the electronic device 100.

For example, the memory 220 may store one or more software applications, such as an operating system (or system) software application, a firmware software application, a driver software application, a plug-in (e.g., add-in, add-on, and/or applet) software application, and/or one or more software applications such as any other suitable software applications. For example, the one or more software applications may include instructions executable by the processor 210. For example, the memory 220 may store instructions that may be called by an application programming interface (API). For example, the memory 220 may store the instructions in a library.

The memory 220 may be configured to store instructions to cause the electronic device 100 to execute at least a portion of the operations exemplified in the description of FIGS. 3 to 18 below. The instructions may be executable by the at least one processor 210.

For example, the electronic device 100 may execute various operations associated with a vehicle character and/or a player character using components exemplified in a description of FIG. 2.

The electronic device 100 may generate an animation representing a player character riding the vehicle character and display the animation in the screen. This operation is exemplified in a description of FIG. 3.

FIG. 3 is a flowchart illustrating an exemplary method of generating an animation by changing a distance between a portion of a vehicle character and a portion of a player character.

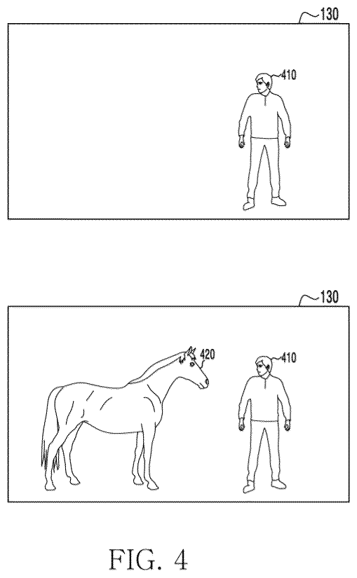

Referring to FIG. 3, in an operation 300, at least one processor 210 may display a screen including a player character on a display 120. The screen is exemplified in a description of FIG. 4.

FIG. 4 illustrates an example of a screen including a player character.

Referring to FIG. 4, for example, a screen 130 provided from a software application for a game may include a player character 410 (e.g., corresponding to a player character 150). For example, the screen 130 provided from the software application may include the player character 410 and a vehicle character 420 (e.g., corresponding to a vehicle character 140). For example, the screen 130 may include or may not include the vehicle character 420 before detecting an event exemplified in a description of an operation 310. For example, display of the vehicle character 420 may vary in accordance with a state of a game service provided via the software application.

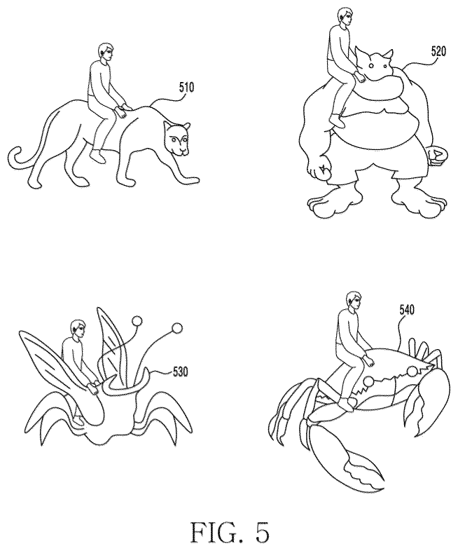

The vehicle character 420 may indicate a visual object that is moved in conjunction with the player character 410 ridden on the vehicle character 420. For example, the vehicle character 420 may have various appearances. An appearance of the vehicle character 420 is exemplified in a description of FIG. 5.

FIG. 5 illustrates an example of an appearance of a vehicle character.

Referring to FIG. 5, as a non-limiting example, a vehicle character 420 may have a shape representing an animal 510. For example, a player character 410 may be ridden on a back of the vehicle character 420 having a shape corresponding to the animal 510.

As a non-limiting example, the vehicle character 420 may have a shape representing a human 520. For example, the player character 410 may be ridden on a shoulder of the vehicle character 420 having the shape corresponding to the human 520. As a non-limiting example, a size of the vehicle character 420 having the shape corresponding to the human 520 may be larger than a size of the player character 410.

As a non-limiting example, the vehicle character 420 may have a shape representing an insect 530. For example, the player character 410 may be ridden on a portion of a tail of the vehicle character 420 having the shape corresponding to the insect 530.

As a non-limiting example, the vehicle character 420 may have a shape representing a crustacean 540. For example, the player character 410 may be ridden on a back of the vehicle character 420 having the shape corresponding to the crustacean 540. However, it is not limited thereto.

As a non-limiting example, a method of generating an animation in advance in which the player character 410 rides the vehicle character 420 and displaying the animation generated in advance when an event occurs in which the player character 410 rides the vehicle character 420 may be considered. However, this method may increase complexity of data management for the game since it is necessary to generate an animation in advance in which the player character 410 rides the vehicle character 420 for each vehicle character 420 of different shapes. This method may increase possibility of occurrence of the data in which correction is omitted.

For example, in the operations exemplified in FIG. 3, based on determining at least one posture 160 by changing a distance between a portion 190 of the vehicle character 140 and a portion 180 of the player character 150, the animation in which the player character 150 rides the vehicle character 140 may be generated. This method may decrease complexity of data management for the game. This method may decrease possibility of occurrence of data in which correction is omitted.

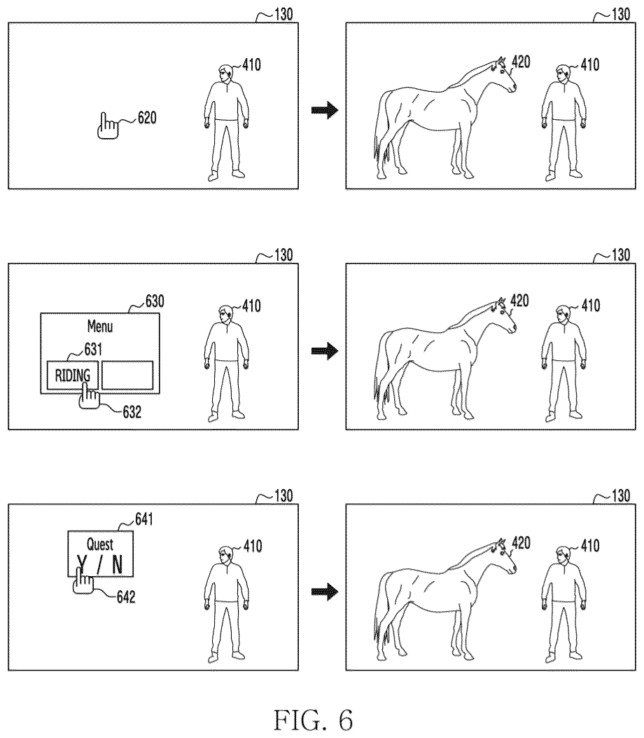

Referring back to FIG. 3, in the operation 310, the at least one processor 210 may detect an event to cause the player character to ride the vehicle character associated with the player character in the screen. The event is exemplified in a description of FIG. 6.

FIG. 6 illustrates an example of an event.

Referring to FIG. 6, as a non-limiting example, the event may include receiving an input 620 for a predetermined area in a screen 130.

As a non-limiting example, a menu window 630 overlapped on the screen 130 may be displayed. For example, the menu window 630 may include an executable object 631 indicating riding a vehicle character 420. For example, the event may include receiving an input 632 for the executable object 631.

As a non-limiting example, a window 641 overlapped on the screen 130 may be displayed. For example, the window 641 may be displayed to ask whether a player character 410 will participate in a quest (or a mission) conducted in a game. For example, the event may include receiving an input 642 indicating that the player character 410 participates in the quest via the window 641. However, it is not limited thereto.

As a non-limiting example, although not described in FIG. 6, the event may include receiving an input via an input device. However, it is not limited thereto.

As a non-limiting example, although not described in FIG. 6, a window indicating a virtual input device may be displayed on the screen 130. For example, the event may include receiving an input for the virtual input device. However, it is not limited thereto.

Referring back to FIG. 3, in an operation 320, the at least one processor 210 may identify a portion of the player character to be linked to a portion of the vehicle character. For example, when the player character rides the vehicle character, the portion of the player character may be linked with the portion of the vehicle character. As a non-limiting example, when the player character rides the vehicle character, the portion of the player character may be contact with the portion of the vehicle character. As a non-limiting example, when the player character rides the vehicle character, the portion of the player character may be spaced apart in a predetermined distance from the portion of the vehicle character. For example, the portion of the player character and the portion of the vehicle character may be predetermined or defined. However, it is not limited thereto.

For example, the portion of the player character may be referred to as a handle or a socket. For example, the portion of the vehicle character may be referred to as a socket (e.g., when the portion of the player character is the handle) or a handle (e.g., when the portion of the player character is the socket). As a non-limiting example, the portion of the player character may include a hand, an elbow, and/or a foot of the player character.

For example, the portion of the vehicle character may be plural. For example, the portion of the player character may be plural. For example, the portion of the player character may include a first portion of the player character corresponding to a first portion of the vehicle character and a second portion of the player character corresponding to a second portion of the vehicle character. As a non-limiting example, portions of different player characters may also be linked to one portion of the vehicle character.

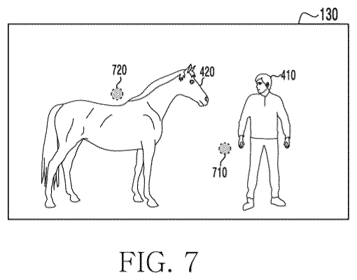

For example, a position of the portion of the vehicle character and a position of the portion of the player character may be variously set. For example, the portion of the player character may be positioned in a portion of a body of the player character. For example, the portion of the vehicle character may be positioned in a portion of a body of the vehicle character. For another example, the portion of the player character may be positioned outside the player character. For another example, the portion of the vehicle character may be positioned outside the vehicle character. The portion of the player character positioned outside the player character and the portion of the vehicle character positioned outside the vehicle character are exemplified in a description of FIG. 7.

FIG. 7 illustrates an example of a portion of a vehicle character positioned outside the vehicle character and a portion of a player character positioned outside the player character.

Referring to FIG. 7, a portion 710 of a player character 410 may be positioned within an area outside the player character 410 associated with the player character 410. For example, the portion 710 of the player character 410 may be positioned within an area outside the player character 410 extended from a portion of a body of the player character 410.

A portion 720 of a vehicle character 420 may be positioned within an area outside the vehicle character 420 associated with the vehicle character 420. For example, the portion 720 of the vehicle character 420 may be positioned within an area outside the vehicle character 420 extended from a portion of a body of the vehicle character 420.

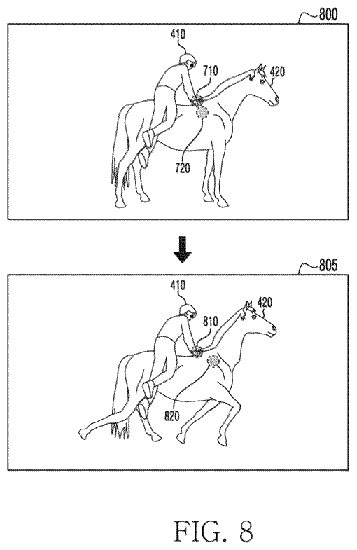

Referring back to FIG. 3, for example, the portion of the vehicle character and the portion of the player character may vary in accordance with a state (e.g., a stopped state/a walking state/a running state) of the vehicle. The portion of the vehicle character and the portion of the player character that may vary in accordance with the state (e.g., the stopped state/the walking state/the running state) of the vehicle are exemplified in a description of FIG. 8.

FIG. 8 illustrates an example of a portion of a vehicle character and a portion of a player character that may vary in accordance with a state of the vehicle.

Referring to FIG. 8, a portion 720 of a vehicle character 420 and/or a portion 710 of a player character 410 may vary in accordance with a state 805 (e.g., a stopped state/a walking state/a running state) of the vehicle character 420.

As a non-limiting example, the portion 720 of the vehicle character 420 and/or the portion 710 of the player character 410 in a stopped state 800 of the vehicle character 420 may be positioned in a portion 820 of the vehicle character 420 and/or a portion 810 of the player character 410 in a running state 805. However, it is not limited thereto.

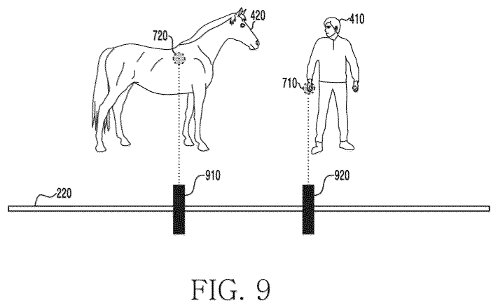

Referring back to FIG. 3, position information of the portion of the vehicle character and position information of the portion of the player character may be stored in advance. For example, the position information of the portion of the vehicle character and the position information of the portion of the player character may be stored in memory 220 in accordance with installation of the software application. The position information of the portion of the vehicle character and the position information of the portion of the player character stored in the memory 220 are exemplified in a description of FIG. 9.

FIG. 9 illustrates an example of position information of a portion of a vehicle character and position information of a portion of a player character.

Referring to FIG. 9, position information 910 of a portion 720 of a vehicle character 420 and position information 920 of a portion 710 of a player character 410 may be stored in memory 220. For example, at least one processor 210 may identify the portion 720 of the vehicle character 420 and the portion 710 of the player character 410 by obtaining the position information 910 and the position information 920 from the memory 220 based on the event detected in the operation 310.

For example, the at least one processor 210 may identify a portion of the player character to be linked to a portion of the vehicle character under a condition that a distance between a representative position (e.g., indicating a position of the vehicle) of the vehicle character and a representative position (e.g., indicating a position of the player character) of the player character reaches a reference distance. For example, the representative position of the player character may be set as a center point between feet of the player character. For example, the representative position of the player character may be referred to as a base of the player character. For example, the representative position of the vehicle character may be set as a center point between feet of the vehicle character. For example, the representative position of the vehicle character may be referred to as a base of the vehicle character.

As a non-limiting example, the reference distance may be set to 0. For example, the at least one processor 210 may identify the portion of the player character to be linked to the portion of the vehicle character based on the representative position of the vehicle character that substantially matches the representative position of the player character.

For example, the at least one processor 210 may detect another event under the condition that the distance between the representative position of the vehicle character and the representative position of the player character reaches the reference distance. For example, the at least one processor 210 may identify the portion of the player character to be linked to the portion of the vehicle character based on the other event. For example, the at least one processor 210 may set a time point at which another event is detected by setting a time period from a time point when the event detected in the operation 310 occurs until the distance between the representative position of the vehicle character and the representative position of the player character reaches the reference distance. For example, the at least one processor 220 may allow the player character to ride the vehicle character at a predetermined time point by setting a time point at which the other event is detected.

Referring back to FIG. 3, in an operation 330, the at least one processor 210 may generate an animation representing the player character riding the vehicle character by changing a distance between the portion of the vehicle character and the portion of the player character. For example, in FIG. 9, the at least one processor 210 may change a distance between the portion 710 of the player character 410 and the portion 720 of the vehicle character 420 by adjusting the position information 910 and the position information 920. For example, adjusting the position information 910 and the position information 920 may be executed until the portion 720 of the vehicle character 420 is linked to the portion 710 of the player character 410.

The distance between the portion of the vehicle character and the portion of the player character may be changed in accordance with an elapse of time. For example, the at least one processor 210 may determine at least one posture of the player character riding the vehicle character and/or at least one posture of the vehicle character ridden by the player character, by changing the distance between the portion of the vehicle character and the portion of the player character.

For example, there may be at least one state between a state before linking the portion of the player character to the portion of the vehicle character and a state in which the player character rides the vehicle character. The distance between the portion of the vehicle character and the portion of the player character in the at least one state may be, in accordance with the change in the distance, between the distance between the portion of the vehicle character and the portion of the player character in the state before linking the portion of the player character to the portion of the vehicle character and the distance between the portion of the vehicle character and the portion of the player character in the state in which the player character rides the vehicle character.

For example, the at least one processor 210 may generate an animation seamlessly representing the player character riding the vehicle character by decreasing the distance between the portion of the vehicle character and the portion of the player character.

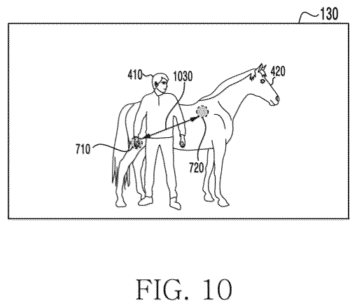

Generating the animation based on changing the distance between the portion of the vehicle character and the portion of the player character is exemplified in a description of FIGS. 10 to 13.

FIG. 10 illustrates an example of a distance between a portion of a vehicle character and a portion of a player character.

Referring to FIG. 10, at least one processor 210 may identify a distance 1030 between a portion 720 of a vehicle character 420 and a portion 710 of the player character 410. For example, the distance 1030 may represent a distance between a representative position of the portion 710 of the player character 410 and a representative position of the portion 720 of the vehicle character 420. For example, the distance 1030 may be identified using position information 910 and position information 920 stored in memory 220.

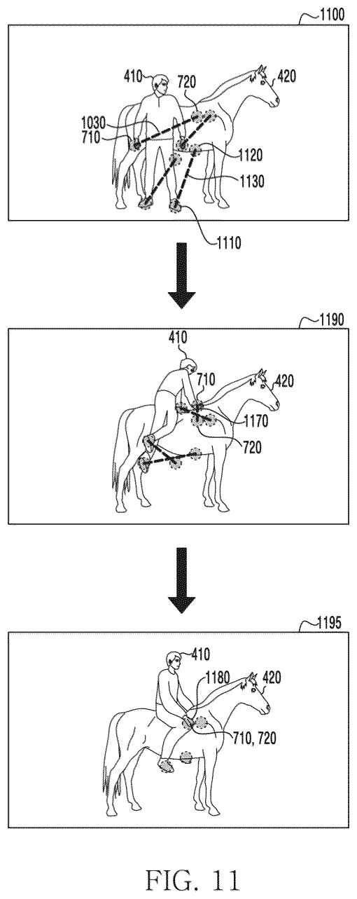

For example, the distance 1030 may be changed to generate the animation. Changing the distance is exemplified in a description of FIG. 11.

FIG. 11 illustrates an example of changing a distance between a portion of a vehicle character and a portion of a player character.

Referring to FIG. 11, at least one processor 210 may generate an animation by changing a distance 1030 between a portion 720 of a vehicle character 420 and a portion 710 of a player character 410.

For example, in a state 1100, the at least one processor 210 may identify the distance between the portion 720 of the vehicle character 420 and the portion 710 of the player character 410 as the distance 1030. For example, in the state 1100, the at least one processor 210 may decrease the distance between the portion 720 of the vehicle character 420 and the portion 710 of the player character 410. For example, the state 1100 may be changed to a state 1190 by decreasing the distance.

For example, in the state 1190, the distance may be a distance 1170 shorter than the distance 1030. For example, the at least one processor 210 may maintain changing the distance until the portion 720 of the vehicle character 420 is linked to the portion 710 of the player character 410. For example, the at least one processor 210 may decrease the distance until reaching a distance 1180 corresponding to the distance when the portion 720 of the vehicle character 420 is linked to the portion 710 of the player character 410, as in a state 1195 changed from the state 1190.

For example, the portion 720 of the vehicle character 420 may be plural. For example, the portion 710 of the player character 410 may be plural. For example, the portion 710 of the player character 410 may include the first portion 710 of the player character 410 corresponding to the first portion 720 of the vehicle character 420 and a second portion 1110 of the player character 410 corresponding to a second portion 1120 of the vehicle character 420.

For example, in the state 1100, the at least one processor 210 may identify the distance between the first portion 720 of the vehicle character 420 and the first portion 710 of the player character 410 as the first distance 1030, and a distance between the second portion 1120 of the vehicle character 420 and the second portion 1110 of the player character 410 as a second distance 1130. For example, in the state 1100, the at least one processor 210 may decrease the first distance 1030 between the first portion 720 of the vehicle character 420 and the first portion 710 of the player character 410 and the second distance 1130 between the second portion 1120 of the vehicle character 420 and the second portion 1110 of the player character 410. For example, the state 1100 may be changed to the state 1190 by decreasing the first distance 1030 and the second distance 1130.

For example, the at least one processor 210 may maintain changing the first distance 1030 and the second distance 1130 until the first portion 720 of the vehicle character 420 is linked to the first portion 710 of the player character 410 and the second portion 1120 of the vehicle character 420 is linked to the second portion 1110 of the player character 410. For example, the at least one processor 210 may decrease the first distance 1030 and the second distance 1130 until reaching the distance 1180 corresponding to the distance when the first portion 720 of the vehicle character 420 is linked to the first portion 710 of the player character 410 and the second portion 1120 of the vehicle character 420 is linked to the second portion 1110 of the player character 410, as in the state 1195 changed from the state 1190.

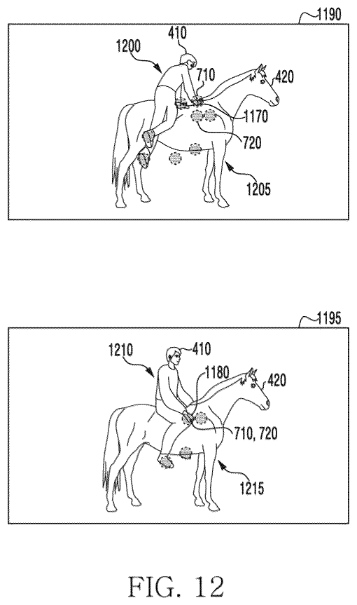

For example, at least one processor 210 may change (or determine) a posture of the player character 410 and a posture of the vehicle character 420 via a fullbody inverse kinematics (IK) algorithm based on decreasing the distance. This operation is exemplified in a description of FIG. 12.

FIG. 12 illustrates an example of generating a posture of a state in which a player character is riding a vehicle character using a fullbody inverse kinematics (IK).

Referring to FIG. 12, for example, in a state 1190, a portion 710 of a player character 410 may be separated by a distance 1170 from a portion 720 of a vehicle character 420 in accordance with a decrease in the distance.

For example, at least one processor 210 may determine a posture 1200 of the player character 410 by applying a fullbody IK algorithm to the portion 710 of the player character 410 separated by the distance 1170 from the portion 720 of the vehicle character 420. For example, the at least one processor 210 may determine a position of at least one joint of the player character 410 associated with the portion 710 of the player character 410 separated by the distance 1170 from the portion 720 of the vehicle character 420, and determine the posture 1200 of the player character 410 in accordance with the determined position.

For example, the at least one processor 210 may determine a posture 1205 of the vehicle character 420 by applying the fullbody IK algorithm to the portion 720 of the vehicle character 420 separated by the distance 1170 from the portion 710 of the player character 410. For example, the at least one processor 210 may determine a position of at least one joint of the vehicle character 420 associated with the portion 720 of the vehicle character 420 separated by the distance 1170 from the portion 710 of the player character 410, and determine the posture 1205 of the vehicle character 420 in accordance with the determined position.

For example, in a state 1195, the portion 710 of the player character 410 may be separated by a distance 1180 from the portion 720 of the vehicle character 420 in accordance with a decrease in the distance.

For example, the at least one processor 210 may determine a posture 1210 of the player character 410 by applying the fullbody IK algorithm to the portion 710 of the player character 410 separated by the distance 1180 from the portion 720 of the vehicle character 420. For example, the at least one processor 210 may determine a position of at least one joint of the player character 410 associated with the portion 710 of the player character 410 separated by the distance 1180 from the portion 720 of the vehicle character 420, and determine the posture 1210 of the player character 410 in accordance with the determined position.

For example, the at least one processor 210 may determine a posture 1215 of the vehicle character 420 by applying the fullbody IK algorithm to the portion 720 of the vehicle character 420 separated by the distance 1180 from the portion 710 of the player character 410. For example, the at least one processor 210 may determine a position of at least one joint of the vehicle character 420 associated with the portion 720 of the vehicle character 420 separated by the distance 1180 from the portion 710 of the player character 410, and determine the posture 1215 of the vehicle character 420 in accordance with the determined position.

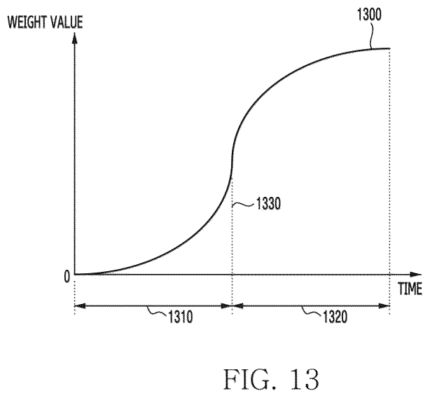

Referring back to FIG. 11, changing the distance (e.g., changing the distance 1030 to the distance 1180 via the distance 1170) may be executed using reference data. For example, the reference data may be previously stored in memory 220. For example, the reference data may be stored for the distance being changed in accordance with an elapse of time in a time interval in which the animation will be displayed. The reference data may indicate a change trend of the distance. The reference data is exemplified in a description of FIG. 13.

FIG. 13 illustrates an example of reference data.

Referring to FIG. 13, a chart 1300 represents reference data used to decrease a distance in accordance with time. A horizontal axis in the chart 1300 represents time, and a vertical axis in the chart 1300 represents a degree to which a distance is changed (hereinafter referred to as a weight value).

For example, the reference data used to decrease the distance may be represented as a line 1300 in the chart 1300.

As a non-limiting example, at least one processor 210 may rapidly change the distance until the distance between a portion 720 of a vehicle character 420 and a portion 710 of a player character 410 reaches a predetermined distance (e.g., corresponding to the distance at time 1330), such as a change in weight values indicated by the line 1300 in a time interval 1310. As a non-limiting example, the at least one processor 210 may rapidly change the distance in the time interval 1310 to enhance a quality of an animation representing the player character 410 riding the vehicle character 420.

As a non-limiting example, the at least one processor 210 may gradually change the distance, after the distance between the portion 720 of the vehicle character 420 and the portion 710 of the player character 410 reaches a predetermined distance (e.g., corresponding to the distance at a time 1330), such as a change in weight values indicated by the line 1300 in a time interval 1320 following the time interval 1310. As a non-limiting example, the at least one processor 210 may gradually change the distance in the time interval 1320 to enhance the quality of the animation representing the player character 410 riding the vehicle character 420.

For example, the weight value may be a value between 0.0 and 1.0. For example, a time when the weight value is 0.0 may be a time when a distance between a representative position (e.g., indicating a position of the vehicle) of the vehicle character 420 and a representative position (e.g., indicating a position of the player character) of the player character 410 reaches a reference distance. For example, the time when the weight value is 0.0 may be a time when the at least one processor 210 identifies the portion 710 of the player character 410 to be linked to the portion 720 of the vehicle character 420. For example, when the weight value is 0.0, the distance between the portion 710 of the player character 410 and the portion 720 of the vehicle character 420 may be the distance between the portion 710 of the player character 410 and the portion 720 of the vehicle character 420 when the at least one processor 210 identifies the portion 710 of the player character 410 to be linked to the portion 710 of the vehicle character 420.

For example, a time when the weight value is 1.0 may be a time when the portion 710 of the player character 410 is linked to the portion 720 of the vehicle character 420. For example, the distance between the portion 720 of the vehicle character 420 and the portion 710 of the player character 410 when the weight value is 1.0 may be the distance when the portion 720 of the vehicle character 420 is linked to the portion 710 of the player character 410.

For example, the at least one processor 210 may set a first weight value at a first time point. As a non-limiting example, the at least one processor 210 may rapidly change the distance until the distance between the portion 720 of the vehicle character 420 and the portion 710 of the player character 410 reaches a predetermined distance (e.g., corresponding to the distance at the first weight value), in a time interval from a time point when the weight value is 0.0 to the first time point. As a non-limiting example, the at least one processor 210 may rapidly change the distance in a time interval from the time point when the weight value is 0.0 to the first time point, in order to enhance the quality of the animation representing the player character 410 riding the vehicle character 420.

As a non-limiting example, the at least one processor 210 may gradually change the distance after the distance between the portion 720 of the vehicle character 420 and the portion 710 of the player character 410 reaches the predetermined distance (e.g., corresponding to the distance at the first weight value), in a time interval from the first time point to a time point when the weight value is 1.0. As a non-limiting example, the at least one processor 210 may gradually change the distance in the time interval from the first time point to the time point when the weight value is 1.0, in order to enhance the quality of the animation representing the player character 410 riding the vehicle character 420.

Referring back to FIG. 3, in an operation 340, the at least one processor 210 may display the animation on the display 120 in response to the event.

For example, the at least one processor 210 may display, on the display 120, the animation seamlessly representing the player character riding the vehicle character by decreasing the distance between the portion of the vehicle character and the portion of the player character.

As described above, an electronic device 100 may decrease complexity of data management by identifying the portion of the player character to be linked to the portion of the vehicle character and changing the distance between the portion of the vehicle character and the portion of the player character to generate an animation.

The electronic device 100 may display, on the display 120, the animation seamlessly representing the player character riding the vehicle character by identifying the portion of the player character to be linked to the portion of the vehicle character and changing the distance between the portion of the vehicle character and the portion of the player character.

The above descriptions exemplify generating the animation representing the player character riding the vehicle character. However, this is only exemplary. Descriptions of FIGS. 3 to 13 may be used to generate an animation representing the player character getting off the vehicle character. For example, the operation 330 may be replaced with an operation generating the animation by increasing the distance between the portion of the vehicle character and the portion of the player character. For example, increasing the distance may be implemented by executing a method of decreasing the distance in a reverse order.

The above descriptions describe operations executed by the electronic device 100, but these are only exemplary. A portion of the operations may be executed in a server to which the electronic device 100 is connected. For example, when the portion of the operations are executed in the server, the at least one processor 210 may transmit, to the server, a request (e.g., a request to identify the portion of the player character to be linked to the portion of the vehicle character) associated with the event, based on the event detected in accordance with the operation 310. For example, the server (or a processor (e.g., including processing circuitry) of the server) may execute the operation 320 and the operation 330 in response to the request. For example, the server may cause the electronic device 100 to perform the operation 340 by transmitting a result of the execution to the electronic device 100 as the response to the request.

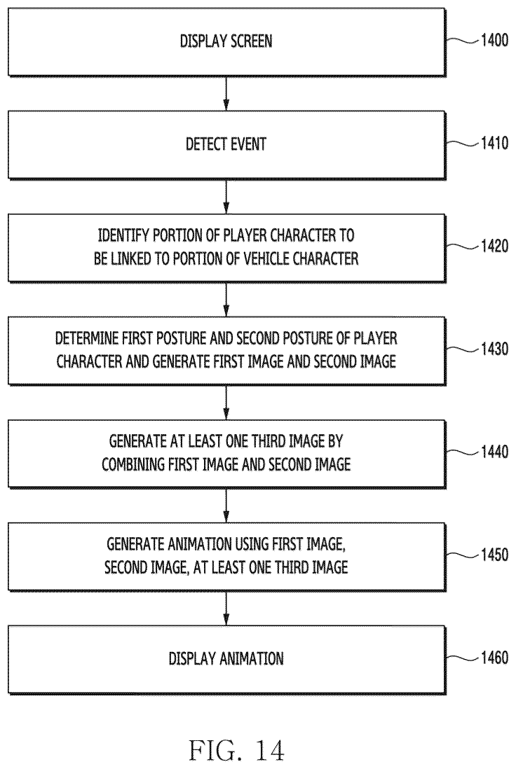

FIG. 14 is a flowchart illustrating an exemplary method of generating an animation using a first image, a second image, and at least one third image.

Referring to FIG. 14, in an operation 1400, at least one processor 210 may display a screen including a player character on a display 120. The screen is exemplified in the description of FIG. 4.

Referring back to FIG. 14, the operation 1400 to an operation 1420 may correspond to the operations 300 to 320 described in FIG. 3. For example, the operation 1400 of FIG. 14 may correspond to the operation 300 of FIG. 3. For example, an operation 1410 of FIG. 14 may correspond to the operation 310 of FIG. 3. For example, an operation 1420 of FIG. 14 may correspond to the operation 320 of FIG. 3.

Contents of the operation 1400 to the operation 1420 may be referred to in the operations 300 to 320 described in FIG. 3.

In an operation 1430, a first posture and a second posture of the player character are determined, and a first image of the first posture and a second image of the second posture are generated.

For example, the first posture may be a posture of the player character before (or immediately before) being ridden on a vehicle character. For example, the second posture may be a posture of the player character after (or immediately after) being ridden on the vehicle character. For example, the first posture and the second posture of the player character may be different from each other. For example, while the player character rides the vehicle character, it may be changed from the first posture to the second posture. For example, the first posture may be changed to the second posture via at least one posture.

For example, the first image may be an image of the posture of the player character before (or immediately before) being ridden on the vehicle character. For example, the second image may be an image of the posture of the player character after (or immediately after) being ridden on the vehicle character.

In an operation 1440, the at least one processor 210 may generate at least one third image by combining the first image and the second image.

For example, the at least one third image may be at least partially different from the first image and the second image. For example, a posture of the at least one third image may be an intermediate posture between the first posture and the second posture.

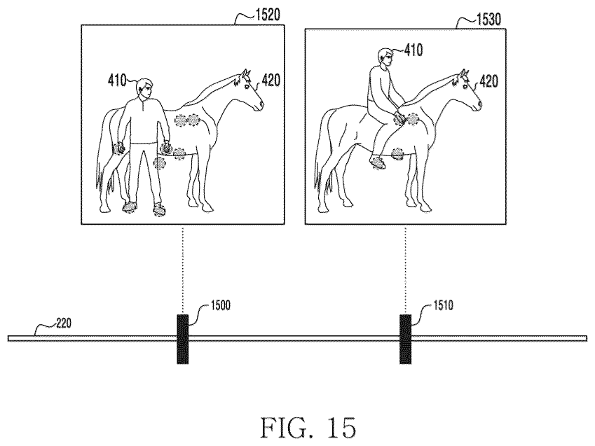

For example, the at least one third image may be generated using a weight of the first image and a weight of the second image. Identifying the weight of the first image and the weight of the second image is exemplified in a description of FIG. 15.

FIG. 15 illustrates an example of a weight of a first image and a weight of a second image stored in memory.

Referring to FIG. 15, a weight 1500 of a first image 1520 and a weight 1510 of a second image 1530 may be stored in memory 220. For example, at least one processor 210 may generate a third image using the first image 1520 and the second image 1530 by identifying and obtaining the weight 1500 and the weight 1510 from the memory 220.

For example, the weight 1500 and the weight 1510 may be changed in accordance with an elapse of time. For example, the at least one processor 210 may determine at least one posture of a player character 410 riding a vehicle character 420 and/or at least one posture of the vehicle character 420 ridden by the player character 410 by adjusting the weight 1500 and the weight 1510.

For example, there may be at least one state between a state before (or immediately before) the player character 410 is ridden on the vehicle character 420 and a state after (or immediately after) the player character 410 is ridden on the vehicle character. The weight 1500 of the first image 1520 in the at least one state may be between a weight of the first image 1520 in the state before (or immediately before) the player character 410 is ridden on the vehicle character 420 and the weight of the first image 1520 in the state after (or immediately after) being ridden on the vehicle character 420, in accordance with the change of the weight 1500.

The weight 1510 of the second image 1530 in the at least one state may be between a weight of the second image 1530 in the state before (or immediately before) the player character 410 is ridden on the vehicle character 420 and a weight of the second image 1530 in the state after (or immediately after) being ridden on the vehicle character, in accordance with the change of the weight 1510.

For example, the at least one processor 210 may change (or determine) the posture of the player character and the posture of the vehicle character via a fullbody inverse kinematics (IK) algorithm based on changing the weight of the first image and the weight of the second image. This operation is exemplified in the description of FIG. 12.

Referring back to FIG. 12, for example, in the state 1190, the portion 710 of the player character 410 may be separated by the distance 1170 from the portion 720 of the vehicle character 420 based on changing the weight of the first image and the weight of the second image.

For example, the at least one processor 210 may determine the posture 1200 of the player character 410 by applying a fullbody IK algorithm to the portion 710 of the player character 410 separated by the distance 1170 from the portion 720 of the vehicle character 420. For example, the at least one processor 210 may determine the position of the at least one joint of the player character 410 associated with the portion 710 of the player character 410 separated by the distance 1170 from the portion 720 of the vehicle character 420, and determine the posture 1200 of the player character 410 in accordance with the determined position.

For example, the at least one processor 210 may determine the posture 1205 of the vehicle character 420 by applying the fullbody IK algorithm to the portion 720 of the vehicle character 420 separated by the distance 1170 from the portion 710 of the player character 410. For example, the at least one processor 210 may determine the position of the at least one joint of the vehicle character 420 associated with the portion 720 of the vehicle character 420 separated by the distance 1170 from the portion 710 of the player character 410, and determine the posture 1205 of the vehicle character 420 in accordance with the determined position.

For example, in a state 1195, the portion 710 of the player character 410 may be separated by the distance 1180 from the portion 720 of the vehicle character 420 based on changing the weight of the first image and the weight of the second image.

For example, the at least one processor 210 may determine the posture 1210 of the player character 410 by applying the fullbody IK algorithm to the portion 710 of the player character 410 separated by the distance 1180 from the portion 720 of the vehicle character 420. For example, the at least one processor 210 may determine the position of the at least one joint of the player character 410 associated with the portion 710 of the player character 410 separated by the distance 1180 from the portion 720 of the vehicle character 420, and determine the posture 1210 of the player character 410 in accordance with the determined position.

For example, the at least one processor 210 may determine the posture 1215 of the vehicle character 420 by applying the fullbody IK algorithm to the portion 720 of the vehicle character 420 separated by the distance 1180 from the portion 710 of the player character 410. For example, the at least one processor 210 may determine the position of the at least one joint of the vehicle character 420 associated with the portion 720 of the vehicle character 420 separated by the distance 1180 from the portion 710 of the player character 410, and determine the posture 1215 of the vehicle character 420 in accordance with the determined position.

Referring back to FIG. 14, in an operation 1450, the at least one processor 210 may generate an animation using the first image, the second image, and the at least one third image. For example, in FIG. 15, the at least one processor 210 may change the weight of the first image and the weight of the second image by adjusting the weight 1500 and the weight 1510. For example, adjusting the weight 1500 and the weight 1510 may be executed until the state after (or immediately after) the player character 410 is ridden on the vehicle character 420.

For example, the weight of the first image and the weight of the second image may be changed in accordance with an elapse of time. For example, the at least one processor 210 may determine at least one posture of the player character 410 riding the vehicle character 420 and/or at least one posture of the vehicle character 420 ridden by the player character 410 by changing the weight of the first image and the weight of the second image. For example, an image for the at least one posture may be the third image.

For example, there may be at least one state between the state before (or immediately before) the player character 410 is ridden on the vehicle character 420 and the state after (or immediately after) the player character 410 is ridden on the vehicle character. The weight of the first image and the weight of the second image in the at least one state may be, in accordance with the change in the weight of the first image and the weight of the second image, between a weight of the first image and a weight of the second image in the state before (or immediately before) the player character is ridden on the vehicle character 420 and a weight of the first image and a weight of the second image in the state after (or immediately after) the player character 410 is ridden on the vehicle character 420.

For example, the at least one processor 210 may generate an animation seamlessly representing the player character riding the vehicle character by connecting the first image, the at least one third image, and the second image.

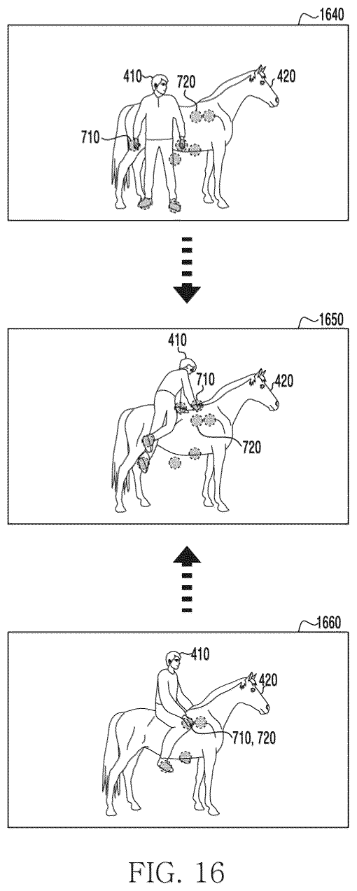

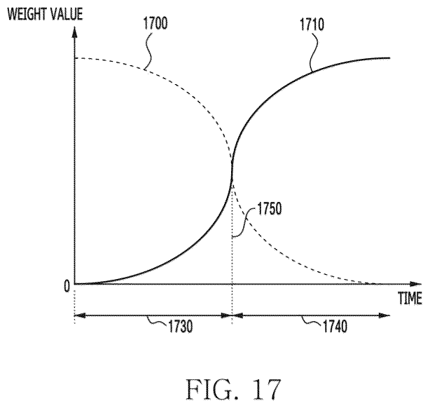

Generating the animation using the first image, the second image, and the at least one third image is exemplified in a description of FIGS. 16 to 17.

FIG. 16 illustrates an example of a first image, a second image, and a third image.

Referring to FIG. 16, at least one processor 210 may generate an animation using a first image, a second image, and at least one third image.

For example, the at least one processor 210 may identify a weight of the first image and a weight of the second image in a state 1640. For example, the at least one processor 210 may decrease the weight of the first image in the state 1640. For example, the at least one processor 210 may increase the weight of the second image in the state 1640. For example, the state 1640 may be changed to a state 1650 by decreasing the weight of the first image and increasing the weight of the second image.

For example, the weight of the first image in the state 1650 may be a value smaller than the weight of the first image in the state 1640. For example, the at least one processor 210 may maintain changing the weight of the first image until a state 1660 after (or immediately after) a player character 410 is ridden on a vehicle character 420. For example, the at least one processor 210 may decrease the weight of the first image until the weight of the first image reaches the weight of the first image of the state 1660 after (or immediately after) being ridden, as in the state 1660 changed from the state 1650.

For example, the weight of the second image in the state 1650 may be a value greater than the weight of the second image in the state 1640. For example, the at least one processor 210 may maintain changing the weight of the second image until the state 1660 after (or immediately after) the player character 410 is ridden on the vehicle character 420. For example, the at least one processor 210 may increase the weight of the second image until the weight of the second image reaches the weight of the second image of the state 1660 after (or immediately after) being ridden, as in the state 1660 changed from the state 1650.

FIG. 17 illustrates an example of reference data.

Referring to FIG. 17, a chart 1700 represents reference data used to decrease a weight of a first image in accordance with time, and a chart 1710 represents reference data used to increase a weight of a second image in accordance with time. A horizontal axis in the chart 1700 and the chart 1710 represents time, and a vertical axis in the chart 1700 and the chart 1710 represents a degree to which a weight is changed (hereinafter referred to as a weight value).

For example, the reference data used to decrease the weight of the first image may be represented as a line 1700 in the chart 1700.

For example, the reference data used to increase the weight of the second image may be represented as a line 1710 in the chart 1710.

As s a non-limiting example, at least one processor 210 may gradually change the weight of the first image until the weight of the first image reaches a predetermined weight (e.g., corresponding to the weight of the first image at a time 1750), such as a change in weight values indicated by the line 1700 in a time interval 1730. As a non-limiting example, the at least one processor 210 may gradually change the weight of the first image in the time interval 1730 to enhance a quality of an animation representing a player character 410 riding a vehicle character 420.

As a non-limiting example, the at least one processor 210 may rapidly change the weight of the second image until the weight of the second image reaches a predetermined weight (e.g., corresponding to the weight of the second image at the time 1750), such as a change in weight values indicated by the line 1710 in the time interval 1730. As a non-limiting example, the at least one processor 210 may rapidly change the weight of the second image in the time interval 1730 to enhance the quality of the animation representing the player character 410 riding the vehicle character 420.

As a non-limiting example, the at least one processor 210 may rapidly change the weight of the first image after the weight of the first image reaches the predetermined weight (e.g., corresponding to the weight of the first image at the time 1750), such as a change in weight values indicated by the line 1700 in the time interval 1740 following the time interval 1730. As a non-limiting example, the at least one processor 210 may rapidly change the weight of the first image in the time interval 1740 to enhance the quality of the animation representing the player character 410 riding the vehicle character 420.

As a non-limiting example, the at least one processor 210 may gradually change the weight of the second image after the weight of the second image reaches the predetermined weight (e.g., corresponding to the weight of the second image at the time 1750), such as a change in weight values indicated by the line 1710 in the time interval 1740 following the time interval 1730. As a non-limiting example, the at least one processor 210 may gradually change the weight of the second image in the time interval 1740 to enhance the quality of the animation representing the player character 410 riding the vehicle character 420.

Referring back to FIG. 14, in an operation 1460, the at least one processor 210 may display the animation on the display 120 in response to the event.

For example, the at least one processor 210 may generate the at least one third image by combining the first and second images, and display, on the display 120, the animation seamlessly representing the player character riding the vehicle character using the first image, the second image, and at least one third image.

As described above, the electronic device 100 may decrease complexity of data management by generating the at least one third image by combining the first image and the second image and generating an animation using the first image, the second image, and the at least one third image.

For example, the at least one processor 210 may generate the at least one third image by combining the first image and second image, and display, on the display 120, the animation seamlessly representing the player character riding the vehicle character using the first image, the second image, and the at least one third image.

The above descriptions exemplify generating the animation representing the player character riding the vehicle character. However, this is only exemplary. Descriptions of FIGS. 4 to 9, 12, and 14 to 17 may be used to generate the animation representing the player character getting off the vehicle character. For example, the operation 1450 may be replaced by an operation using an animation by connecting the second image, the at least one third image, and the first image. For example, a method of using the second image, the at least one third image, and the first image may be implemented by executing a method of using the first image, the at least one third image, and the second image in a reverse order.

The descriptions of FIGS. 14 to 17 describe operations executed by the electronic device 100, but these are only exemplary. A portion of the operations may be executed in a server to which the electronic device 100 is connected. For example, when the portion of the operations is executed in the server, at least one processor 210 may transmit, to the server, a request (e.g., a request to identify the portion of the player character to be linked to the portion of the vehicle character) associated with the event, based on the event detected in accordance with the operation 1410. For example, the server (or a processor (e.g., including processing circuitry) of the server) may execute the operation 1430, the operation 1440, and the operation 1450 in response to the request. For example, the server may cause the electronic device 100 to perform the operation 1460 by transmitting a result of the execution to the electronic device 100 as the response to the request.

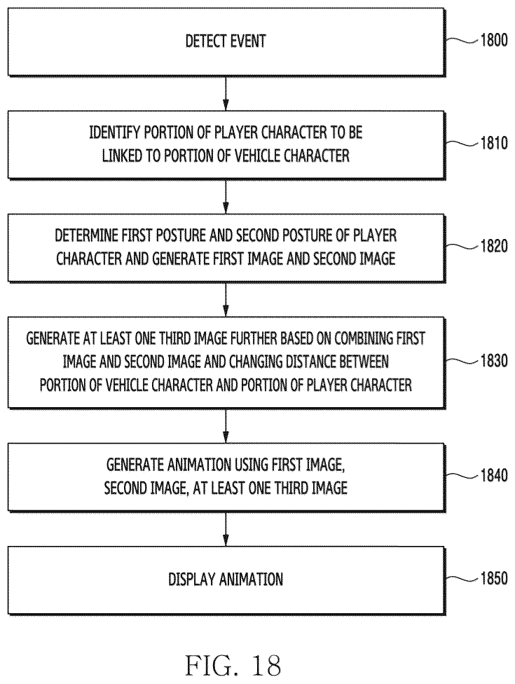

FIG. 18 is a flowchart of generating an animation using a first image, a second image, and at least one third image by generating the at least one third image, further based on changing a distance between a portion of a vehicle character and a portion of a player character.

Referring to FIG. 18, an operation 1800 and an operation 1810 may correspond to the operation 310 and the operation 320 described in FIG. 3. For example, the operation 1800 of FIG. 18 may correspond to the operation 310 of FIG. 3. For example, the operation 1810 of FIG. 18 may correspond to the operation 320 of FIG. 3.

Contents of the operation 1800 and the operation 1810 may be referred to in the operation 310 and the operation 320 described in FIG. 3. In an operation 1820, at least one processor 210 determines a first posture of a player character before linking a portion of the player character to a portion of a vehicle character, determines a second posture of the player character riding the vehicle character, and generates a first image of the first posture and a second image of the second posture.

For example, the first posture may be a posture of the player character before (or immediately before) being ridden on the vehicle character. For example, the second posture may be a posture of the player character after (or immediately after) being ridden on the vehicle character. For example, the first posture and the second posture of the player character may be different from each other. For example, while the player character rides the vehicle character, it may be changed from the first posture to the second posture. For example, the first posture may be changed to the second posture via at least one posture.

For example, the first image may be an image of the posture of the player character before (or immediately before) being ridden on the vehicle character. For example, the second image may be an image of the posture of the player character after (or immediately after) being ridden on the vehicle character.

In an operation 1830, the at least one processor 210 may generate at least one third image further based on combining the first image and the second image and changing a distance between the portion of the vehicle character and the portion of the player character.

For example, the at least one third image may be at least partially different from the first image and the second image. For example, a posture of the at least one third image may be an intermediate posture between the first posture and the second posture.

Position information of the portion of the vehicle character and position information of the portion of the player character may be stored in advance. For example, the position information of the portion of the vehicle character and the position information of the portion of the player character may be stored in memory 220 in accordance with installation of the software application. The position information of the portion of the vehicle character and the position information of the portion of the player character stored in the memory 220 are exemplified in a description of FIG. 9.

Referring back to FIG. 9, the position information 910 of the portion 720 of the vehicle character 420 and the position information 920 of the portion 710 of the player character 410 may be stored in the memory 220. For example, the at least one processor 210 may change a distance between the portion 710 of the player character 410 and the portion 720 of the vehicle character 420 by adjusting the position information 910 and the position information 920. For example, adjusting the position information 910 and the position information 920 may be executed until the portion 720 of the vehicle character 420 is linked to the portion 710 of the player character 410.

Referring back to FIG. 18, a weight of the first image and a weight of the second image may be stored in advance. For example, the weight of the first image and the weight of the second image may be stored in the memory 220 in accordance with installation of the software application. The weight of the first image and the weight of the second image stored in the memory 220 are exemplified in the description of FIG. 15.

Referring back to FIG. 15, the weight 1500 of the first image 1520 and the weight 1510 of the second image 1530 may be stored in advance. For example, the at least one processor 210 may generate the third image further based on using the first image 1520 and the second image 1530 by obtaining the weight 1500 and the weight 1510 from the memory 220 and changing the distance between a portion of the vehicle character and a portion of a player character.

For example, the weight 1500 and the weight 1510 may be changed in accordance with an elapse of time. For example, the at least one processor 210 may determine at least one posture of the player character 410 riding the vehicle character 420 and/or at least one posture of the vehicle character 420 ridden by the player character 410 further based on adjusting the weight 1500 and the weight 1510 and changing the distance between the portion of the vehicle character and the portion of the player character.

For example, there may be at least one state between a state before (or immediately before) the player character 410 is ridden on the vehicle character 420 and a state after (or immediately after) the player character 410 is ridden on the vehicle character. The weight 1500 of the first image 1520 in the at least one state may be between a weight in the state before (or immediately before) the player character 410 is ridden on the vehicle character 420 and a weight in the state after (or immediately after) being ridden on the vehicle character, in accordance with a change of the weight 1500.

The weight 1510 of the second image 1530 in the at least one state may be, in accordance with a change of the weight 1510, between a weight in the state before (or immediately before) the player character 410 is ridden on the vehicle character 420 and a weight in the state after (or immediately after) being ridden on the vehicle character.

For example, the distance between the portion of the vehicle character and the portion of the player character may be between a distance between the portion of the vehicle character and the portion of the player character in the state before (or immediately before) the player character 410 is ridden on the vehicle character 420, and a distance between the portion of the vehicle character and the portion of the player character in the state after (or immediately after) being ridden on the vehicle character.

For example, the at least one processor 210 may change (or determine) the posture of the player character and the posture of the vehicle character via the fullbody inverse kinematics (IK) algorithm further based on changing the weight of the first image and the weight of the second image and changing the distance between the portion of the vehicle character and the portion of the player character. This operation is exemplified in the description of FIG. 12.

Referring back to FIG. 12, for example, in the state 1190, the portion 710 of the player character 410 may be separated by the distance 1170 from the portion 720 of the vehicle character 420 further based on changing the weight of the first image and the weight of the second image and changing the distance between the portion of the vehicle character and the portion of the player character.

For example, the at least one processor 210 may determine the posture 1200 of the player character 410 by applying the fullbody IK algorithm to the portion 710 of the player character 410 separated by the distance 1170 from the portion 720 of the vehicle character 420. For example, the at least one processor 210 may determine the position of the at least one joint of the player character 410 associated with the portion 710 of the player character 410 separated by the distance 1170 from the portion 720 of the vehicle character 420, and determine the posture 1200 of the player character 410 in accordance with the determined position.

For example, the at least one processor 210 may determine the posture 1205 of the vehicle character 420 by applying the fullbody IK algorithm to the portion 720 of the vehicle character 420 separated by the distance 1170 from the portion 710 of the player character 410. For example, the at least one processor 210 may determine the position of the at least one joint of the vehicle character 420 associated with the portion 720 of the vehicle character 420 separated by the distance 1170 from the portion 710 of the player character 410, and determine the posture 1205 of the vehicle character 420 in accordance with the determined position.

For example, in the state 1195, the portion 710 of the player character 410 may be separated by the distance 1180 from the portion 720 of the vehicle character 420 based on changing the weight of the first image and the weight of the second image.

For example, the at least one processor 210 may determine the posture 1210 of the player character 410 by applying the fullbody IK algorithm to the portion 710 of the player character 410 separated by the distance 1180 from the portion 720 of the vehicle character 420. For example, the at least one processor 210 may determine the position of the at least one joint of the player character 410 associated with the portion 710 of the player character 410 separated by the distance 1180 from the portion 720 of the vehicle character 420, and determine the posture 1210 of the player character 410 in accordance with the determined position.

For example, the at least one processor 210 may determine the posture 1215 of the vehicle character 420 by applying the fullbody IK algorithm to the portion 720 of the vehicle character 420 separated by the distance 1180 from the portion 710 of the player character 410. For example, the at least one processor 210 may determine the position of the at least one joint of the vehicle character 420 associated with the portion 720 of the vehicle character 420 separated by the distance 1180 from the portion 710 of the player character 410, and determine the posture 1215 of the vehicle character 420 in accordance with the determined position.

Referring back to FIG. 18, in an operation 1840, the at least one processor 210 may generate an animation using the first image, the second image, and the at least one third image. For example, in FIG. 15, the at least one processor 210 may change the weight of the first image and the weight of the second image by adjusting the weight 1500 and the weight 1510. For example, adjusting the weight 1500 and the weight 1510 may be executed until the state after (or immediately after) the player character 410 is ridden on the vehicle character 420. For example, the weight of the first image and the weight of the second image may be changed in accordance with an elapse of time. For example, the at least one processor 210 may determine at least one posture of the player character riding the vehicle character and/or at least one posture of the vehicle character ridden by the player character further based on changing the weight of the first image and the weight of the second image and changing the distance between the portion of the vehicle character and the portion of the player character. For example, an image for the at least one posture may be the third image.

For example, there may be at least one state between a state before (or immediately before) the player character 410 is ridden on the vehicle character 420 and a state after (or immediately after) the player character 410 is ridden on the vehicle character. The weight of the first image and the weight of the second image in the at least one state may be, in accordance with the change in the weight of the first image and the weight of the second image, between a weight of the first image and a weight of the second image in the state before (or immediately before) the player character rides the vehicle character 420 and a weight of the first image and a weight of the second image in the state after (or immediately after) the player character 410 is ridden on the vehicle character 420.

The distance between the portion of the vehicle character and the portion of the player character in the at least one state may be, in accordance with the change in the distance, between a distance between the portion of the vehicle character and the portion of the player character in a state before linking the portion of the player character to the portion of the vehicle character and a distance between the portion of the vehicle character and the portion of the player character in a state in which the player character rides the vehicle character.

For example, the at least one processor 210 may generate an animation seamlessly representing the player character riding the vehicle character by connecting the first image, the at least one third image, and the second image.

Generating the animation using the first image, the second image, and the at least one third image is exemplified in the description of FIG. 16.

Referring back to FIG. 16, the at least one processor 210 may generate the animation using the first image, the second image, and the at least one third image.

For example, the at least one processor 210 may identify the weight of the first image and the weight of the second image in the state 1640. For example, the at least one processor 210 may identify the distance between the portion 720 of the vehicle character 420 and the portion 710 of the player character 410 in the state 1640.

For example, the at least one processor 210 may decrease the weight of the first image in the state 1640. For example, the at least one processor 210 may increase the weight of the second image in the state 1640. For example, the at least one processor 210 may decrease the distance between the portion 720 of the vehicle character 420 and the portion 710 of the player character 410 in the state 1640.

For example, the state 1640 may be changed to the state 1650 by decreasing the weight of the first image, increasing the weight of the second image, and decreasing the distance between the portion 720 of the vehicle character 420 and the portion 710 of the player character 410.

For example, the weight of the first image in the state 1650 may be a value smaller than the weight of the first image in the state 1640. For example, the at least one processor 210 may maintain changing the weight of the first image until the state 1660 after (or immediately after) the player character 410 is ridden on the vehicle character 420. For example, the at least one processor 210 may decrease the weight of the first image until the weight of the first image reaches the weight of the first image of the state 1660 after (or immediately after) being ridden, as in the state 1660 changed from the state 1650.

For example, the weight of the second image in the state 1650 may be a value greater than the weight of the second image in the state 1640. For example, the at least one processor 210 may maintain changing the weight of the second image until the state 1660 after (or immediately after) the player character 410 is ridden on the vehicle character 420. For example, the at least one processor 210 may increase the weight of the second image until the weight of the second image reaches the weight of the second image of the state 1660 after (or immediately after) being ridden, as in the state 1660 changed from the state 1650.

For example, the distance in the state 1650 may be a distance shorter than the distance in the 1640. For example, the at least one processor 210 may maintain changing the distance until the portion 720 of the vehicle character 420 is linked to the portion 710 of the player character 410. For example, the at least one processor 210 may decrease the distance until reaching a distance corresponding to the distance when the portion 720 of the vehicle character 420 is linked to the portion 710 of the player character 410, as in the state 1660 changed from the state 1650.

Referring back to FIG. 18, in an operation 1850, the at least one processor 210 may display the animation on a display 120 in response to the event.

For example, the at least one processor 210 may generate the at least one third image further based on combining the first image and the second image and changing the distance between the portion of the vehicle character and the portion of the player character, and display, on the display 120, the animation seamlessly representing the player character riding the vehicle character using the first image, the second image, and the at least one third image.

As described above, an electronic device 100 may decrease complexity of data management by generating the at least one third image further based on combining the first image and the second image and changing the distance between the portion of the vehicle character and the portion of player character, and by generating an animation using the first image, the second image, and the at least one third image.

The electronic device 100 may generate the at least one third image further based on combining the first image and the second image and changing the distance between the vehicle character and the player character, and display, on the display 120, the animation seamlessly representing the player character riding the vehicle character using the first image, the second image, and the at least one third image.

The above descriptions exemplify generating the animation representing the player character riding the vehicle character. However, this is only exemplary. Descriptions of FIGS. 6 to 9, 12, and 16 to 18 may be used to generate an animation representing the player character getting off the vehicle character. For example, the operation 1840 may be replaced by an operation generating an animation using the second image, the at least one third image, and the first image. For example, a method of using the second image, the at least one third image, and the first image may be implemented by executing a method of using the first image, the at least one third image, and the second image in a reverse order.

Descriptions of FIG. 18 describe operations executed by the electronic device 100, but these are only exemplary. A portion of the operations may be executed in a server to which the electronic device 100 is connected. For example, when the portion of the operations is executed in the server, the at least one processor 210 may transmit, to the server, a request (e.g., a request to identify the portion of the player character to be linked to the portion of the vehicle character) associated with the event based on the event detected in accordance with the operation 1800. For example, the server (or a processor (e.g., including processing circuitry) of the server) may execute the operation 1810 to the operation 1840 in response to the request. For example, the server may cause the electronic device 100 to perform the operation 1850 by transmitting a result of the execution to the electronic device 100 as the response to the request.

The electronic device 100 exemplified above may include a display (e.g., the display 120), but the operations exemplified above may be executed in another electronic device that do not include a display. For example, the other electronic device may be connected to a display device positioned outside the other electronic device. For example, displaying an animation on the display 120 among the operations of the electronic device 100 exemplified above may be replaced by controlling or causing the display device positioned outside the other electronic device to display the animation using a processor of the other electronic device.

According to an embodiment, the electronic device may generate an animation and cause it to be displayed on the display. For example, the electronic device may require a method to generate an animation representing a player character riding a vehicle character by identifying a portion of the player character to be linked to a portion of the vehicle character when the player character is ridden on the vehicle character and changing a distance between the portion of the vehicle character and the portion of the player character.

As described above, an electronic device may include memory storing instructions. The electronic device may include a display. The electronic device may include at least one processor. The instructions, when executed by the at least one processor individually or collectively, may cause the electronic device to display a screen on the display. The instructions, when executed by the at least one processor individually or collectively, may cause the electronic device to, while the screen is displayed, detect an event to cause a player character to ride a vehicle character associated with the player character in the screen. The instructions, when executed by the at least one processor individually or collectively, may cause the electronic device to identify a portion of the player character to be linked to a portion of the vehicle character when the player character is ridden on the vehicle character, based on the event. The instructions, when executed by the at least one processor individually or collectively, may cause the electronic device to generate an animation representing the player character riding the vehicle character by changing a distance between the portion of the vehicle character and the portion of the player character. The instructions, when executed by the at least one processor individually or collectively, may cause the electronic device to display the animation on the display in response to the event. According to an embodiment, the electronic device may cause an animation to be generated and displayed on the display. For example, the electronic device may identify a portion of the player character to be linked to a portion of the vehicle character when the player character is ridden on the vehicle character, and generate an animation representing the player character riding the vehicle character by changing a distance between the portion of the vehicle character and the portion of the player character.

According to an embodiment, the vehicle character may be moved toward the player character in response to the event, and the instructions, when executed by the at least one processor individually or collectively, may cause the electronic device to identify a distance between the vehicle character moved in response to the event and the player character, and based on identifying that the distance between the vehicle character and the player character reaches in (or becomes less than) a reference distance, display the animation.

According to an embodiment, the distance between the vehicle character and the player character may be a distance between a representative position of the player character and a representative position of the vehicle character, and the representative position of the player character may be in between two feet of the player character.

According to an embodiment, reference data on the distance being changed in accordance with (or based on) an elapse of time in a time interval in which the animation will be displayed may be store in the electronic device. The instructions, when executed by the at least one processor individually or collectively, may cause the electronic device to generate the animation by changing the distance using the reference data.

According to an embodiment, the instructions, when executed by the at least one processor individually or collectively, may cause the electronic device to generate the animation by changing the distance via applying a weight to the reference data.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the instructions, when executed by the at least one processor individually or collectively, may cause the electronic device to identify a movement state of the vehicle character moved toward the player character in response to the event, while (or based on) identifying that the movement state is a first movement state, identify the portion of the player character to be linked to the portion of the vehicle character when the player character is ridden on the vehicle character, and generate the animation by changing the distance between the portion of the vehicle character and the portion of the player character, while identifying that the movement state is a second movement state, identify another portion of the player character to be linked to another portion of the vehicle character when the player character is ridden on the vehicle character, and generate another animation by changing a distance between the another portion of the vehicle character and the another portion of the player character, and display the animation and the another animation on the display as the response to the event.

According to an embodiment, the instructions, when executed by the at least one processor individually or collectively, may cause the electronic device to identify another portion of the player character to be linked to another portion of the vehicle character when the player character is ridden on the vehicle character based on the event, generate the animation representing the player character riding the vehicle character by changing the distance and a distance between the another portion of the vehicle character, and the another portion of the player character, and display the animation on the display in response to the event.

According to an embodiment, the instructions, when executed by the at least one processor individually or collectively, may cause the electronic device to change the distance by decreasing the distance.

The instructions may cause the electronic device to, while the distance is decreased, determine (or identify) a first posture of the player character to be ridden on the vehicle character in accordance with the portion of the player character separated from the portion of the vehicle character by a first distance, and determine a second posture of the player character to be ridden on the vehicle character in accordance with the portion of the player character separated from the portion of the vehicle character by a second distance shorter than the first distance, and based on the first posture and the second posture, generate the animation.

The second posture may be at least partially different from the first posture.

As described above, a method performed by an electronic device my include displaying a screen on the display. The method may include, while the screen is displayed, detecting an event to cause a player character to ride a vehicle character associated with the player character in the screen. The method may include identifying a portion of the player character to be linked to a portion of the vehicle character when the player character is ridden on the vehicle character, based on the event. The method may include generating an animation representing the player character riding the vehicle character by changing a distance between the portion of the vehicle character and the portion of the player character. The method may include displaying the animation on the display in response to the event.

According to an embodiment, the vehicle character may be moved toward the player character in response to the event, and the method may include identifying a distance between the vehicle character moved in response to the event and the player character, and based on identifying that the distance between the vehicle character and the player character reaches in a reference distance, displaying the animation.

According to an embodiment, the distance between the vehicle character and the player character may be a distance between a representative position of the player character and a representative position of the vehicle character, and the representative position of the player character may be in between two feet of the player character.

According to an embodiment, the method may include identifying reference data on the distance being changed in accordance with an elapse of time in a time interval in which the animation will be displayed, and generating the animation by changing the distance using the reference data.

According to an embodiment, the method may include generating the animation by changing the distance via applying a weight to the reference data.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the method may include identifying a movement state of the vehicle character moved toward the player character in response to the event, while identifying that the movement state is a first movement state, identifying the portion of the player character to be linked to the portion of the vehicle character when the player character is ridden on the vehicle character, and generating the animation by changing the distance between the portion of the vehicle character and the portion of the player character, while identifying that the movement state is a second movement state, identifying another portion of the player character to be linked to another portion of the vehicle character when the player character is ridden on the vehicle character, and generating another animation by changing a distance between the another portion of the vehicle character and the another portion of the player character, and displaying the animation and the another animation on the display as the response to the event.

According to an embodiment, the method may include identifying another portion of the player character to be linked to another portion of the vehicle character when the player character is ridden on the vehicle character based on the event, generating the animation representing the player character riding the vehicle character by changing the distance and a distance between the another portion of the vehicle character, and the another portion of the player character, and displaying the animation on the display in response to the event.

According to an embodiment, the method may include changing the distance by decreasing the distance, while the distance is decreased, determining a first posture of the player character to be ridden on the vehicle character in accordance with the portion of the player character separated from the portion of the vehicle character by a first distance, and determining a second posture of the player character to be ridden on the vehicle character in accordance with the portion of the player character separated from the portion of the vehicle character by a second distance shorter than the first distance, and based on the first posture and the second posture, generating the animation. The second posture may be at least partially different from the first posture.

As described above, in a computer readable storage medium in which one or more programs are stored, the one or more programs may comprise instructions, when executed by a processor of an electronic device, to cause the electronic device to display a screen on the display. The one or more programs may comprise instructions, when executed by the electronic device, to cause the electronic device to, while the screen is displayed, detect an event to cause a player character to ride a vehicle character associated with the player character in the screen. The one or more programs may comprise instructions, when executed by the electronic device, to cause the electronic device to identify a portion of the player character to be linked to a portion of the vehicle character when the player character is ridden on the vehicle character, based on the event. The one or more programs may comprise instructions, when executed by the electronic device, to cause the electronic device to generate an animation representing the player character riding the vehicle character by changing a distance between the portion of the vehicle character and the portion of the player character. The one or more programs may comprise instructions, when executed by the electronic device, to cause the electronic device to display the animation on the display in response to the event.

According to an embodiment, the vehicle character may be moved toward the player character in response to the event, and the one or more programs may comprise instructions, when executed by the electronic device, to cause the electronic device to identify a distance between the vehicle character moved in response to the event and the player character, and based on identifying that the distance between the vehicle character and the player character reaches in a reference distance, display the animation.

According to an embodiment, the distance between the vehicle character and the player character may be a distance between a representative position of the player character and a representative position of the vehicle character, and the representative position of the player character may be in between two feet of the player character.

According to an embodiment, the one or more programs may comprise instructions, when executed by the electronic device, to cause the electronic device to identify reference data on the distance being changed in accordance with an elapse of time in a time interval in which the animation will be displayed, and generate the animation by changing the distance using the reference data.

According to an embodiment, the one or more programs may comprise instructions, when executed by the electronic device, to cause the electronic device to generate the animation by changing the distance via applying a weight to the reference data.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the one or more programs may comprise instructions, when executed by the electronic device, to cause the electronic device to identify a movement state of the vehicle character moved toward the player character in response to the event, while identifying that the movement state is a first movement state, identify the portion of the player character to be linked to the portion of the vehicle character when the player character is ridden on the vehicle character, and generate the animation by changing the distance between the portion of the vehicle character and the portion of the player character, while identifying that the movement state is a second movement state, identify another portion of the player character to be linked to another portion of the vehicle character when the player character is ridden on the vehicle character, and generate another animation by changing a distance between the another portion of the vehicle character and the another portion of the player character, and display the animation and the another animation on the display as the response to the event.

According to an embodiment, the one or more programs may comprise instructions, when executed by the electronic device, to cause the electronic device to identify another portion of the player character to be linked to another portion of the vehicle character when the player character is ridden on the vehicle character based on the event, generate the animation representing the player character riding the vehicle character by changing the distance and a distance between the another portion of the vehicle character, and the another portion of the player character, and display the animation on the display in response to the event.

According to an embodiment, the one or more programs may comprise instructions, when executed by the electronic device, to cause the electronic device to change the distance by decreasing the distance.

The one or more programs may comprise instructions to cause the electronic device to, while the distance is decreased, determine a first posture of the player character to be ridden on the vehicle character in accordance with the portion of the player character separated from the portion of the vehicle character by a first distance, and determine a second posture of the player character to be ridden on the vehicle character in accordance with the portion of the player character separated from the portion of the vehicle character by a second distance shorter than the first distance, and based on the first posture and the second posture, generate the animation. The second posture may be at least partially different from the first posture.

As described above, an electronic device may include memory storing instructions. The electronic device may include a display. The electronic device may include at least one processor. The instructions, when executed by the at least one processor individually or collectively, may cause the electronic device to display a screen on the display. The instructions, when executed by the at least one processor individually or collectively, may cause the electronic device to, while the screen is displayed, detect an event to cause a player character to ride a vehicle character associated with the player character in the screen. The instructions, when executed by the at least one processor individually or collectively, may cause the electronic device to identify a portion of the player character to be linked to a portion of the vehicle character when the player character is ridden on the vehicle character, based on the event. The instructions, when executed by the at least one processor individually or collectively, may cause the electronic device to determine a first posture of the player character before linking the portion of the player character to the portion of the vehicle character moved toward the player character in response to the event. The instructions, when executed by the at least one processor individually or collectively, may cause the electronic device to determine a second posture of the player character by linking the portion of the player character to the portion of the vehicle character. The instructions, when executed by the at least one processor individually or collectively, may cause the electronic device to generate a first image including the player character having the first posture and a second image including the player character having the second posture. The instructions, when executed by the at least one processor individually or collectively, may cause the electronic device to generate at least one third image by combining the first image and the second image. The instructions, when executed by the at least one processor individually or collectively, may cause the electronic device to generate an animation using the first image, the second image, and the at least one third image. The instructions, when executed by the at least one processor individually or collectively, may cause the electronic device to display the animation on the display in response to the event.

According to an embodiment, the vehicle character may be moved toward the player character in response to the event, and the instructions, when executed by the at least one processor individually or collectively, may cause the electronic device to identify a distance between the vehicle character moved in response to the event and the player character, and based on identifying that the distance between the vehicle character and the player character reaches in a reference distance, display the animation.

According to an embodiment, the distance between the vehicle character and the player character may be a distance between a representative position of the player character and a representative position of the vehicle character, and the representative position of the player character may be in between two feet of the player character.

According to an embodiment, the instructions, when executed by the at least one processor individually or collectively, may cause the electronic device to identify reference data on a first weight to be applied to the first image and a second weight to be applied to the second image, and generate the at least one third image by combining the first image and the second image via applying the first weight from the reference data to the first image and applying the second weight from the reference data to the second image. The first weight and the second weight may be changed in accordance with an elapse of time in a time interval in which the animation will be displayed.

According to an embodiment, the instructions, when executed by the at least one processor individually or collectively, may cause the electronic device to, further based on changing a distance between the portion of the vehicle character and the portion of the player character, generate the at least one third image, and generate the animation using the first image, the second image, and the at least one third image.

According to an embodiment, the instructions, when executed by the at least one processor individually or collectively, may cause the electronic device to identify other reference data on the distance being changed in accordance with an elapse of time in a time interval in which the animation will be displayed, and further based on changing the distance using the other reference data, generate the at least one third image.

According to an embodiment, the instructions, when executed by the at least one processor individually or collectively, may cause the electronic device to, based on applying a weight to the reference data and applying another weight to the other reference data, generate the at least one third image.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the instructions, when executed by the at least one processor individually or collectively, may cause the electronic device to identify a movement state of the vehicle character moved toward the player character in response to the event, while identifying that the movement state is a first movement state, generate the at least one third image by combining the first image and the second image, while identifying that the movement state is a second movement state, identify another portion of the player character to be linked to another portion of the vehicle character when the player character is ridden on the vehicle character, determine a third posture of the player character before linking the another portion of the player character to the another portion of the vehicle character moved toward the player character in response to the event, determine a fourth posture of the player character by linking the another portion of the player character to the another portion of the vehicle character, generate a fourth image including the player character having the third posture and a fifth image including the player character having the fourth posture, and generate at least one sixth image by combining the fourth image and the fifth image, and generate the animation by combining the first image, the second image, the at least one third image, the fourth image, the fifth image, and the at least one sixth image.

According to an embodiment, the instructions, when executed by the at least one processor individually or collectively, may cause the electronic device to identify another portion of the player character to be linked to another portion of the vehicle character when the player character is ridden on the vehicle character, based on the event, determine the first posture of the player character before linking the portion of the player character to the portion of the vehicle character moved toward the player character in response to the event and before linking the another portion of the player character to the another portion of the vehicle character, and determine the second posture of the player character by linking the portion of the player character to the portion of the vehicle character and by linking the another portion of the player character to the another portion of the vehicle character.

As described above, a method performed by an electronic device may include displaying a screen on the display. The method may include, while the screen is displayed, detecting an event to cause a player character to ride a vehicle character associated with the player character in the screen. The method may include identifying a portion of the player character to be linked to a portion of the vehicle character when the player character is ridden on the vehicle character, based on the event. The method may include determining a first posture of the player character before linking the portion of the player character to the portion of the vehicle character moved toward the player character in response to the event. The method may include determining a second posture of the player character by linking the portion of the player character to the portion of the vehicle character. The method may include generating a first image including the player character having the first posture and a second image including the player character having the second posture. The method may include generating at least one third image by combining the first image and the second image. The method may include generating an animation using the first image, the second image, and the at least one third image. The method may include displaying the animation on the display in response to the event.

According to an embodiment, the vehicle character may be moved toward the player character in response to the event, and the method may include identifying a distance between the vehicle character moved in response to the event and the player character, and based on identifying that the distance between the vehicle character and the player character reaches in a reference distance, displaying the animation.

According to an embodiment, the distance between the vehicle character and the player character may be a distance between a representative position of the player character and a representative position of the vehicle character, and the representative position of the player character may be in between two feet of the player character.

According to an embodiment, the method may include identifying reference data on a first weight to be applied to the first image and a second weight to be applied to the second image, and generating the at least one third image by combining the first image and the second image via applying the first weight from the reference data to the first image and applying the second weight from the reference data to the second image. The first weight and the second weight may be changed in accordance with an elapse of time in a time interval in which the animation will be displayed.

According to an embodiment, the method may include, further based on changing a distance between the portion of the vehicle character and the portion of the player character, generating the at least one third image, and generating the animation using the first image, the second image, and the at least one third image.

According to an embodiment, the method may include identifying other reference data on the distance being changed in accordance with an elapse of time in a time interval in which the animation will be displayed, and further based on changing the distance using the other reference data, generating the at least one third image.

According to an embodiment, the method may include, based on applying a weight to the reference data and applying another weight to the other reference data, generating the at least one third image.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the method may include identifying a movement state of the vehicle character moved toward the player character in response to the event, while identifying that the movement state is a first movement state, generating the at least one third image by combining the first image and the second image, while identifying that the movement state is a second movement state, identifying another portion of the player character to be linked to another portion of the vehicle character when the player character is ridden on the vehicle character, determining a third posture of the player character before linking the another portion of the player character to the another portion of the vehicle character moved toward the player character in response to the event, determine a fourth posture of the player character by linking the another portion of the player character to the another portion of the vehicle character, generating a fourth image including the player character having the third posture and a fifth image including the player character having the fourth posture, and generating at least one sixth image by combining the fourth image and the fifth image, and generating the animation by combining the first image, the second image, the at least one third image, the fourth image, the fifth image, and the at least one sixth image.

According to an embodiment, the method may include identifying another portion of the player character to be linked to another portion of the vehicle character when the player character is ridden on the vehicle character, based on the event, determining the first posture of the player character before linking the portion of the player character to the portion of the vehicle character moved toward the player character in response to the event and before linking the another portion of the player character to the another portion of the vehicle character, and determining the second posture of the player character by linking the portion of the player character to the portion of the vehicle character and by linking the another portion of the player character to the another portion of the vehicle character.

As described above, in a computer readable storage medium storing one or more programs, the one or more programs may comprise instructions, when executed by a processor of an electronic device, to cause the electronic device to display a screen on the display. The one or more programs may comprise instructions, when executed by the electronic device, to cause the electronic device to, while the screen is displayed, detect an event to cause a player character to ride a vehicle character associated with the player character in the screen. The one or more programs may comprise instructions, when executed by the electronic device, to cause the electronic device to identify a portion of the player character to be linked to a portion of the vehicle character when the player character is ridden on the vehicle character, based on the event. The one or more programs may comprise instructions, when executed by the electronic device, to cause the electronic device to determine (or identify) a first posture of the player character before linking the portion of the player character to the portion of the vehicle character moved toward the player character in response to the event. The one or more programs may comprise instructions, when executed by the electronic device, to cause the electronic device to determine a second posture of the player character by linking the portion of the player character to the portion of the vehicle character. The one or more programs may comprise instructions, when executed by the electronic device, to cause the electronic device to generate a first image including the player character having the first posture and a second image including the player character having the second posture. The one or more programs may comprise instructions, when executed by the electronic device, to cause the electronic device to generate at least one third image by combining the first image and the second image. The one or more programs may comprise instructions, when executed by the electronic device, to cause the electronic device to generate an animation using the first image, the second image, and the at least one third image. The one or more programs may comprise instructions, when executed by the electronic device, to cause the electronic device to display the animation on the display in response to the event.

According to an embodiment, the vehicle character may be moved toward the player character in response to the event, and the one or more programs may comprise instructions, when executed by the electronic device, to cause the electronic device to identify a distance between the vehicle character moved in response to the event and the player character, and based on identifying that the distance between the vehicle character and the player character reaches in a reference distance, display the animation.

According to an embodiment, the distance between the vehicle character and the player character may be a distance between a representative position of the player character and a representative position of the vehicle character, and the representative position of the player character may be in between two feet of the player character.

According to an embodiment, the one or more programs may comprise instructions, when executed by the electronic device, to cause the electronic device to identify reference data on a first weight to be applied to the first image and a second weight to be applied to the second image, and generate the at least one third image by combining the first image and the second image via applying the first weight from the reference data to the first image and applying the second weight from the reference data to the second image. The first weight and the second weight may be changed in accordance with an elapse of time in a time interval in which the animation will be displayed.

According to an embodiment, the one or more programs may comprise instructions, when executed by the electronic device, to cause the electronic device to, further based on changing a distance between the portion of the vehicle character and the portion of the player character, generate the at least one third image, and generate the animation using the first image, the second image, and the at least one third image.

According to an embodiment, the one or more programs may comprise instructions, when executed by the electronic device, to cause the electronic device to identify other reference data on the distance being changed in accordance with an elapse of time in a time interval in which the animation will be displayed, and further based on changing the distance using the other reference data, generate the at least one third image.

According to an embodiment, the one or more programs may comprise instructions, when executed by the electronic device, to cause the electronic device to, based on applying a weight to the reference data and applying another weight to the other reference data, generate the at least one third image.

According to an embodiment, the portion of the player character may be positioned within an area outside the player character, extended from a portion of a body of the player character, associated with the player character.

According to an embodiment, the portion of the vehicle character may be positioned within an area outside the vehicle character, extended from a portion of a body of the vehicle character, associated with the vehicle character.

According to an embodiment, the vehicle character may be moved toward the player character in response to the event, and the one or more programs may comprise instructions, when executed by the electronic device, to cause the electronic device to identify a movement state of the vehicle character moved toward the player character in response to the event, while identifying that the movement state is a first movement state, generate the at least one third image by combining the first image and the second image, while identifying that the movement state is a second movement state, identify another portion of the player character to be linked to another portion of the vehicle character when the player character is ridden on the vehicle character, determine a third posture of the player character before linking the another portion of the player character to the another portion of the vehicle character moved toward the player character in response to the event, determine a fourth posture of the player character by linking the another portion of the player character to the another portion of the vehicle character, generate a fourth image including the player character having the third posture and a fifth image including the player character having the fourth posture, and generate at least one sixth image by combining the fourth image and the fifth image, and generate the animation by combining the first image, the second image, the at least one third image, the fourth image, the fifth image, and the at least one sixth image.

According to an embodiment, the one or more programs may comprise instructions, when executed by the electronic device, to cause the electronic device to identify another portion of the player character to be linked to another portion of the vehicle character when the player character is ridden on the vehicle character, based on the event, determine the first posture of the player character before linking the portion of the player character to the portion of the vehicle character moved toward the player character in response to the event and before linking the another portion of the player character to the another portion of the vehicle character and determine the second posture of the player character by linking the portion of the player character to the portion of the vehicle character, and by linking the another portion of the player character to the another portion of the vehicle character.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A non-transitory computer readable storage medium storing one or more programs, the one or more programs comprising instructions that, when executed by an electronic device having a display, cause the electronic device to:
display a screen on the display;
while the screen is displayed, detect an event to cause a player character to ride a vehicle character associated with the player character in the screen;
identify a portion of the player character to be linked to a portion of the vehicle character when the player character is ridden on the vehicle character;
generate an animation representing the player character riding the vehicle character by changing a distance between the portion of the vehicle character and the portion of the player character; and
display the animation on the display.

2. The non-transitory computer readable storage medium of claim 1, wherein the one or more programs comprise instructions that, when executed by the electronic device, cause the electronic device to:
identify a distance between the vehicle character and the player character, and
based on identifying that the distance between the vehicle character and the player character becomes less than a reference distance, display the animation.

3. The non-transitory computer readable storage medium of claim 2, wherein the distance between the vehicle character and the player character is a distance between a representative position of the player character and a representative position of the vehicle character, and
wherein the representative position of the player character is in between two feet of the player character.

4. The non-transitory computer readable storage medium of claim 1, wherein the one or more programs comprise instructions that, when executed by the electronic device, cause the electronic device to:
identify reference data on the distance being changed in accordance with an elapse of time in a time interval in which the animation will be displayed; and
generate the animation by changing the distance using the reference data.

5. The non-transitory computer readable storage medium of claim 4, wherein the one or more programs comprise instructions that, when executed by the electronic device, cause the electronic device to generate the animation by changing the distance by applying a weight to the reference data.

6. The non-transitory computer readable storage medium of claim 1, wherein the portion of the player character positioned within an area outside the player character, extended from a portion of a body of the player character, associated with the player character.

7. The non-transitory computer readable storage medium of claim 1, wherein the portion of the vehicle character is positioned within an area outside the vehicle character, extended from a portion of a body of the vehicle character, associated with the vehicle character.

8. The non-transitory computer readable storage medium of claim 1, wherein the one or more programs comprise instructions that, when executed by the electronic device, cause the electronic device to:
identify a movement state of the vehicle character;
based on identifying that the movement state is a first movement state:
identify the portion of the player character to be linked to the portion of the vehicle character when the player character is ridden on the vehicle character; and
generate the animation by changing the distance between the portion of the vehicle character and the portion of the player character,
based on identifying that the movement state is a second movement state:
identify another portion of the player character to be linked to another portion of the vehicle character when the player character is ridden on the vehicle character; and
generate another animation by changing a distance between the another portion of the vehicle character and the another portion of the player character; and
display the animation and the another animation on the display.

9. The non-transitory computer readable storage medium of claim 1, wherein the one or more programs comprise instructions that, when executed by the electronic device, cause the electronic device to:
identify another portion of the player character to be linked to another portion of the vehicle character when the player character is ridden on the vehicle character;
generate the animation representing the player character riding the vehicle character by changing a distance between the another portion of the vehicle character and the another portion of the player character; and
display the animation on the display.

10. The non-transitory computer readable storage medium of claim 1, wherein the one or more programs comprise instructions that, when executed by the electronic device, cause the electronic device to:
change the distance by decreasing the distance;
while the distance is being decreased:
identify a first posture of the player character to be ridden on the vehicle character in accordance with the portion of the player character separated from the portion of the vehicle character by a first distance; and
identify a second posture of the player character to be ridden on the vehicle character in accordance with the portion of the player character separated from the portion of the vehicle character by a second distance shorter than the first distance; and
based on the first posture and the second posture, generate the animation,
wherein the second posture is at least partially different from the first posture.

11. A non-transitory computer readable storage medium storing one or more programs, the one or more programs comprising instructions that, when executed by an electronic device having a display, cause the electronic device to:
display a screen on the display;
while the screen is displayed, detect an event to cause a player character to ride a vehicle character associated with the player character in the screen;
identify a portion of the player character to be linked to a portion of the vehicle character when the player character is ridden on the vehicle character;
identify a first posture of the player character before linking the portion of the player character to the portion of the vehicle character;
identify a second posture of the player character by linking the portion of the player character to the portion of the vehicle character;
generate a first image including the player character having the first posture and a second image including the player character having the second posture;
generate at least one third image by combining the first image and the second image;
generate an animation using the first image, the second image, and the at least one third image; and
display the animation on the display.

12. The non-transitory computer readable storage medium of claim 11, wherein the one or more programs comprise instructions that, when executed by the electronic device, cause the electronic device to:
identify a distance between the vehicle character and the player character; and
based on identifying that the distance between the vehicle character and the player character becomes less than a reference distance, display the animation.

13. The non-transitory computer readable storage medium of claim 12, wherein the distance between the vehicle character and the player character is a distance between a representative position of the player character and a representative position of the vehicle character, and
wherein the representative position of the player character is in between two feet of the player character.

14. The non-transitory computer readable storage medium of claim 11, wherein the one or more programs comprise instructions that, when executed by the electronic device, cause the electronic device to:
identify reference data on a first weight to be applied to the first image and a second weight to be applied to the second image; and
generate the at least one third image by combining the first image and the second image via applying the first weight from the reference data to the first image and applying the second weight from the reference data to the second image, and
wherein the first weight and the second weight are changed based on an elapse of time in a time interval in which the animation will be displayed.

15. The non-transitory computer readable storage medium of claim 14, wherein the one or more programs comprise instructions that, when executed by the electronic device, cause the electronic device to:
based on changing a distance between the portion of the vehicle character and the portion of the player character, generate the at least one third image; and
generate the animation using the first image, the second image, and the at least one third image.

16. The non-transitory computer readable storage medium of claim 15, wherein the one or more programs comprise instructions that, when executed by the electronic device, cause the electronic device to:
identify other reference data on the distance being changed based on the elapse of time in the time interval in which the animation will be displayed; and
based on changing the distance using the other reference data, generate the at least one third image.

17. The non-transitory computer readable storage medium of claim 16, wherein the one or more programs comprise instructions that, when executed by the electronic device, cause the electronic device to, based on applying a weight to the reference data and applying another weight to the other reference data, generate the at least one third image.

18. The non-transitory computer readable storage medium of claim 11, wherein the portion of the player character is positioned within an area outside the player character, extended from a portion of a body of the player character, associated with the player character.

19. The non-transitory computer readable storage medium of claim 11, wherein the portion of the vehicle character is positioned within an area outside the vehicle character, extended from a portion of a body of the vehicle character, associated with the vehicle character.

20. The non-transitory computer readable storage medium of claim 11, wherein the one or more programs comprise instructions that, when executed by the electronic device, cause the electronic device to:
identify a movement state of the vehicle character;
based on identifying that the movement state is a first movement state, generate the at least one third image by combining the first image and the second image;
based on identifying that the movement state is a second movement state:
identify another portion of the player character to be linked to another portion of the vehicle character when the player character is ridden on the vehicle character;
identify a third posture of the player character before linking the another portion of the player character to the another portion of the vehicle character;
identify a fourth posture of the player character by linking the another portion of the player character to the another portion of the vehicle character;
generate a fourth image including the player character having the third posture and a fifth image including the player character having the fourth posture;
generate at least one sixth image by combining the fourth image and the fifth image; and
generate the animation by combining the first image, the second image, the at least one third image, the fourth image, the fifth image, and the at least one sixth image.
